(19) United States
(12) Patent Application Publication
(10) Pub. No.: US 2024/0259797 A1
(43) Pub. Date: Aug. 1, 2024

(54) SUPPORTING REMOTE USER EQUIPMENT AUTHENTICATION VIA RELAY USER EQUIPMENT

(71) Applicant: Telefonaktiebolaget LM Ericsson (publ), STOCKHOLM (SE)

(72) Inventors: Zhang Fu, STOCKHOLM (SE); Monica Wifvesson, LUND (SE); Ivo Sedlacek, HOVORCOVICE (CZ)

(21) Appl. No.: 18/019,048

(22) PCT Filed: Aug. 23, 2022
(86) PCT No.: PCT/IB2022/057906

§ 371 Date: Jan. 31, 2023

Related U.S. Application Data
(60) Provisional application No. 63/294,920, filed on Dec. 30, 2021.

(51) Int. Cl. H04W 12/06; H04W 12/08

(52) U.S. Cl. CPC H04W 12/06; H04W 12/08

(57) ABSTRACT

Systems and methods are disclosed for supporting remote User Equipment (UE) authentication via a relay UE. In one embodiment, a method performed by a relay UE comprises receiving a first message conveyed by a remote UE and sending a second message to a relay access and mobility function (AMF), wherein the second message comprises a UE-to-Network (U2N) connection mapping identification (ID) that identifies the remote UE. In this manner, the relay UE and relay AMF are able to identify that the second message (e.g., an authentication related message) is for the remote UE. Embodiments of a relay UE and embodiments of a relay AMF and methods of operation thereof are also disclosed.

### RELATED APPLICATIONS

This application claims the benefit of provisional patent application Ser. No. 63/294,920, filed Dec. 30, 2021, the disclosure of which is hereby incorporated herein by reference in its entirety.

### TECHNICAL FIELD

Disclosed are embodiments related to functionality to support authentication of a remote user equipment (UE) via a relay UE.

### BACKGROUND

### Background of Control Plane Based Solution for Remote UE Authorization

3rd Generation Partnership Project (3GPP) Technical Specification (TS) 33.503 v0.2.0 clause 6.3.3.3, which is reproduced below, specifies a Control Plane based solution for remote User Equipment (UE) authorization. In 3GPP TS 33.503 v0.2.0 clause 6.3.3.3, PC5 is a reference point where the UE directly communicates with another UE, ID stands for identification, AMF stands for Access and Mobility Function, AUSF stands for Authentication Server Function, UDM stands for Unified Data Management, 5G stands for next generation, PCF stands for Policy Control Function, DCR stands for Direct Communication Request, SUCI stands for Subscription Concealed Identifier, U2N stands for UE-to-Network, NAS stands for Non-Access Stratum, SMC stands for Security Mode Command, and FFS stands for Further Study. FIG. 1 shows FIG. 6.3.3.3.2-1 of 3GPP TS 33.503 v0.2.0.

### *****START EXCERPT FROM 3GPP TS 33.503*****

6.3.3.3 Security procedure over Control Plane
   Editor's Notes: This clause describes the security procedure that relies on primary authentication procedure to authenticate/authorize UE during 5G ProSe UE-to-Network Relay Communication.
6.3.3.3.1 General
This subclause describes the security mechanisms for the L3 U2N Relay authentication, authorization and key management using the primary authentication for PC5 keys establishment. Network entities AMF, AUSF and UDM are involved for key derivation and distribution of keys used for UE-to-network relay communication. The UE shall be provisioned with necessary policies and parameters to use 5G ProSe services, as part of the UE ProSe Policy information as defined in TS 23.503 . . . clause 4.2.2. PCF shall provision the authorization policy and parameters for 5G UE-to-Network Relay Discovery and Communication as specified in 5.1.4 in TS 23.304 . . . .
6.3.3.3.2 Connection with UE-to-Network Relay connection with setup of network Prose security context during PC5 link establishment
This subclause describes a procedure for a Remote UE to establish a PC5 link between a Remote UE and a UE-to-Network relay. The procedure includes how the Remote UE is authenticated by AUSF via Relay UE and Relay UE's AMF during 5G ProSe PC5 establishment. The mechanism can be used by a Remote UE while out of coverage.
[FIG. 6.3.3.3.2-1 of 3GPP TS 33.503 v0.2.0 is shown in FIG. 1]
FIG. 6.3.3.3.2-1: UE-to-Network Relay security procedure with setup of network Prose security context during PC5 link establishment
0. The Remote UE and relay UE shall be registered with the network. The UE-to-Network relay shall be authenticated and authorized by the network to support as a relay UE. Remote UE shall be authenticated and authorized by the network to act as a Remote UE.
1. The remote UE shall initiate discovery procedure using any of Model A or Model B method as specified in clause 6.3.1.2 or 6.3.1.3 of TS 23.304 . . . respectively.
2-5. After the discovery of the UE-to-Network relay, the Remote UE shall send a Direct Communication Request to the relay UE for establishing secure PC5 unicast link. The Remote UE shall include its security capabilities and security policy in the DCR message as specified in TS 33.536 . . . . The message shall also include SUCI, Relay Service Code, Nonce_1. Upon receiving the DCR message, the Relay UE shall send the relay key request to the relay AMF, including the parameters received in the DCR message. The Relay AMF shall verify whether the relay UE is authorized to act as U2N relay. The relay AMF shall select AUSF based on SUCI and forward the key request to the AUSF in Nausf_UEAuthentication_Authenticate Request message.
6-7. The AUSF shall retrieve the Authentication Vectors from the UDM and trigger primary authentication of the remote UE using existing procedure as specified in TS 33.501 . . . . This authentication is performed between the AUSF and the remote UE via the relay AMF and relay UE. AUSF shall not make the newly derived KAUSF as the latest KAUSF. At the remote UE, the newly derived KAUSF shall not be taken as latest KAUSF as NAS SMC procedure is not performed between remote UE and relay AMF.
Editor's note: Further details on authentication message handling in UE, Relay UE's AMF and AUSF are FFS.
Editor's note: There are essentially two different KAUSF keys. Different key names should be used to avoid confusion and misleading. This is FFS.
Editor's note: A new service operations should be used for Prose authentication to distinguish it from primary authentication defined in 33.501, to separate the different function and service logic. This is FFS.
8. On successful primary authentication, the AUSF and Remote UE shall generate 5GPRUK (as specified in Annex A.2) and 5GPRUK ID as specified in Annex A.3 using the newly derived KAUSF.
9. The AUSF shall generate the KNR_ProSe key as defined in Annex A.4.
10-11. The AUSF shall send the 5GPRUK ID, KNR_ProSe, Nonce_2 in Nausf_UEAuthentication_Authenticate Response message to the UE-to-Network relay via relay AMF. When receiving a KNR_ProSe from AUSF, the AMF shall not attempt to trigger NAS SMC procedure with Remote UE. Relay UE derives PC5 session key Krelay-sess and confidentiality and integrity keys from KNR_ProSe, using the KDF defined in clause 6.3.3.3.4 of this document. KNR_ProSe ID and Krelay-sess ID are established in the same way as KNRP ID and KNRP-sess ID in TS 33.536 [6].
12. The UE-to-Network relay shall send the received 5GPRUK ID, Nonce_2 to the Remote UE in Direct Security mode command message.
13-14. The remote UE shall use the 5GPRUK ID to locate the KAUSF/5GPRUK to be used for the PC5 link security. Remote UE shall generate the KNR_ProSe key to be used for Remote access via the Relay UE in the same way as defined in step 9. The Remote UE shall derive PC5 session key Krelay-sess and confidentiality and integrity keys from KNR_ProSe the same way as defined in step 11. Remote UE shall send the Direct Security mode complete message to the UE-to-Network relay.
Further communication between Remote UE and Network takes place securely via the UE-to-Network relay.
Editor's note: Further details on the needs and usage of 5GPRUK ID are FFS.

### *****END EXCERPT FROM 3GPP TS 33.503*****

### Background about UE Authentication

3GPP TS 24.501 v17.4.0 clause 5.4.1.2 specifies and Extensible Authentication Protocol (EAP) based primary authentication and key agreement procedure and is reproduced below. In 3GPP TS 24.501, ngKSI stands for Key Set Identifier for Next Generation Radio Access Network, and 5GMM stands for 5G System Mobility Management. FIG. 2 shows FIG. 5.4.1.2.1.1 of 3GPP TS 24.501.

### *****START EXCERPT FROM 3GPP TS 24.501*****

5.4.1.2 EAP based primary authentication and key agreement procedure
5.4.1.2.1 General
The purpose of the EAP based primary authentication and key agreement procedure is to provide mutual authentication between the UE and the network and to agree on the keys KAUSF, KSEAF and KAMF (see 3GPP TS 33.501 . . . ).
Extensible authentication protocol (EAP) as specified in IETF RFC 3748 . . . enables authentication using various EAP methods.
EAP defines four types of EAP messages:
a) an EAP-request message;
b) an EAP-response message;
c) an EAP-success message; and
d) an EAP-failure message.
Several rounds of exchanges of an EAP-request message and a related EAP-response message can be required to achieve the authentication (see example in FIG. 5.4.1.2.1.1).
The EAP based primary authentication and key agreement procedure is always initiated and controlled by the network.
The EAP-request message, the ngKSI and the ABBA are transported from the network to the UE using the AUTHENTICATION REQUEST message of the EAP message reliable transport procedure.
The EAP-response message is transported from the UE to the network using the AUTHENTICATION RESPONSE message of the EAP message reliable transport procedure.
If the authentication of the UE completes successfully, the serving AMF intends to initiate a security mode control procedure after the EAP based primary authentication and key agreement procedure and the security mode control procedure intends to bring into use the partial native 5G NAS security context created by the EAP based primary authentication and key agreement procedure, then the EAP-success message and the ngKSI are transported from the network to the UE using the SECURITY MODE COMMAND message of the security mode control procedure (see subclause 5.4.2).
If the authentication of the UE completes successfully and the serving AMF does not intend to initiate a security mode control procedure bringing into use the partial native 5G NAS security context created by the EAP based primary authentication and key agreement procedure, then the EAP-success message, and the ngKSI are transported from the network to the UE using the AUTHENTICATION RESULT message of the EAP result message transport procedure.
NOTE 1: The serving AMF will not initiate a security mode control procedure after the EAP based primary authentication and key agreement procedure e.g. in case of AMF relocation during registration procedure.
If the authentication of the UE completes unsuccessfully, the EAP-failure message is transported from the network to the UE using the AUTHENTICATION RESULT message or the AUTHENTICATION REJECT message of the EAP result message transport procedure or in a response of the initial 5GMM procedure as part of which the EAP based primary authentication and key agreement procedure is performed.
The AMF shall set the authenticator retransmission timer specified in IETF RFC 3748 [34] subclause 4.3 to infinite value.
NOTE 2: The EAP message reliable transport procedure provides a reliable transport of EAP messages and therefore retransmissions at the EAP layer do not occur.
The AUSF and the AMF support exchange of EAP messages using N12.
The UE shall detect and handle any duplication of EAP message as specified in IETF RFC 3748 . . . .
[FIG. 5.4.1.2.1.1 of 3GPP TS 24.501 is shown in FIG. 2]
FIG. 5.4.1.2.1.1: EAP based primary authentication and key agreement procedure

### *****END EXCERPT FROM 3GPP TS 24.501*****

3GPP TS 24.501 clauses 8.2.1 to 8.2.5 define the messages used for UE authentication. The clauses are reproduced below.

### *****START EXCERPT FROM 3GPP TS 24.501*****

8.2.1 Authentication request
8.2.1.1 Message definition
The AUTHENTICATION REQUEST message is sent by the AMF to the UE to initiate authentication of the UE identity. See table 8.2.1.1.1.
Message type: AUTHENTICATION REQUEST
Significance: dual
Direction: network to UE

TABLE 82.1.1.1
AUTHENTICATION REQUEST message content

| IEI | Information Element | Type/Reference | Presence | Format | Length |
|---|---|---|---|---|---|
| | Extended protocol | Extended protocol discriminator | M | V | 1 |
| | discriminator | 9.2 | | | |
| | Security header type | Security header type | M | V | ½ |
| | | 9.3 | | | |
| | Spare half octet | Spare half octet | M | V | ½ |
| | | 9.5 | | | |
| | Authentication request | Message type | M | V | 1 |
| | message identity | 9.7 | | | |
| | ngKSI | NAS key set identifier | M | V | ½ |
| | | 9.11.3.32 | | | |
| | Spare half octet | Spare half octet | M | V | ½ |
| | | 9.5 | | | |
| | ABBA | ABBA | M | LV | 3-n |
| | | 9.11.3.10 | | | |
| 21 | Authentication parameter | Authentication parameter RAND | O | TV | 17 |
| | RAND (5G authentication | 9.11.3.16 | | | |
| | challenge) | | | | |
| 20 | Authentication parameter | Authentication parameter AUTN | O | TLV | 18 |
| | AUTN (5G authentication | 9.11.3.15 | | | |
| | challenge) | | | | |
| 78 | EAP message | EAP message | O | TLV-E | 7-1503 |
| | | 9.11.2.2 | | | |

8.2.2 Authentication response
8.2.2.1 Message definition
The AUTHENTICATION RESPONSE message is sent by the UE to the AMF to deliver a calculated authentication response to the network. See table 8.2.2.1.1.
Message type: AUTHENTICATION RESPONSE
Significance: dual
Direction: UE to network

TABLE 82.2.1.1
AUTHENTICATION RESPONSE message content

| IEI | Information Element | Type/Reference | Presence | Format | Length |
|---|---|---|---|---|---|
| | Extended protocol | Extended protocol discriminator | M | V | 1 |
| | discriminator | 9.2 | | | |
| | Security header type | Security header type | M | V | ½ |
| | | 9.3 | | | |
| | Spare half octet | Spare half octet | M | V | ½ |
| | | 9.5 | | | |
| | Authentication response | Message type | M | V | 1 |
| | message identity | 9.7 | | | |
| 2D | Authentication response | Authentication response | O | TLV | 18 |
| | parameter | parameter | | | |
| | | 9.11.3.17 | | | |
| 78 | EAP message | EAP message | O | TLV-E | 7-1503 |
| | | 9.11.2.2 | | | |

8.2.3 Authentication result
8.2.3.1 Message definition
The AUTHENTICATION RESULT message is sent by the AMF to the UE to provide result of EAP authentication of the UE identity. See table 8.2.3.1.1.
Message type: AUTHENTICATION RESULT
Significance: dual
Direction: network to UE

TABLE 82.3.1.1
AUTHENTICATION RESULT message content

| IEI | Information Element | Type/Reference | Presence | Format | Length |
|---|---|---|---|---|---|
| | Extended protocol | Extended protocol discriminator | M | V | 1 |
| | discriminator | 9.2 | | | |
| | Security header type | Security header type | M | V | ½ |
| | | 9.3 | | | |
| | Spare half octet | Spare half octet | M | V | ½ |
| | | 9.5 | | | |
| | Authentication result message | Message type | M | V | 1 |
| | identity | 9.7 | | | |
| | ngKSI | NAS key set identifier | M | V | ½ |
| | | 9.11.3.32 | | | |
| | Spare half octet | Spare half octet | M | V | ½ |
| | | 9.5 | | | |
| | EAP message | EAP message | M | LV-E | 6-1502 |
| | | 9.11.2.2 | | | |
| 38 | ABBA | ABBA | O | TLV | 4-n |
| | | 9.11.3.10 | | | |

8.2.4 Authentication failure
8.2.4.1 Message definition
The AUTHENTICATION FAILURE message is sent by the UE to the AMF to indicate that authentication of the network has failed. See table 8.2.4.1.1.
Message type: AUTHENTICATION FAILURE
Significance: dual
Direction: UE to network

TABLE 82.4.1.1
AUTHENTICATION FAILURE message content

| IEI | Information Element | Type/Reference | Presence | Format | Length |
|---|---|---|---|---|---|
| | Extended protocol | Extended protocol discriminator | M | V | 1 |
| | discriminator | 9.2 | | | |
| | Security header type | Security header type | M | V | ½ |
| | | 9.3 | | | |
| | Spare half octet | Spare half octet | M | V | ½ |
| | | 9.5 | | | |
| | Authentication failure message | Message type | M | V | 1 |
| | identity | 9.7 | | | |
| | 5GMM cause | 5GMM cause | M | V | 1 |
| | | 9.11.3.2 | | | |
| 30 | Authentication failure | Authentication failure parameter | O | TLV | 16 |
| | parameter | 9.11.3.14 | | | |

8.2.5 Authentication reject
8.2.5.1 Message definition
The AUTHENTICATION REJECT message is sent by the AMF to the UE to indicate that the authentication procedure has failed and that the UE shall abort all activities. See table 8.2.5.1.1.
Message type: AUTHENTICATION REJECT
Significance: dual
Direction: network to UE

TABLE 82.5.1.1
AUTHENTICATION REJECT message content

| IEI | Information Element | Type/Reference | Presence | Format | Length |
|---|---|---|---|---|---|
| | Extended protocol | Extended protocol discriminator | M | V | 1 |
| | discriminator | 9.2 | | | |
| | Security header type | Security header type | M | V | ½ |
| | | 9.3 | | | |
| | Spare half octet | Spare half octet | M | V | ½ |
| | | 9.5 | | | |
| | Authentication reject message | Message type | M | V | 1 |
| | identity | 9.7 | | | |
| 78 | EAP message | EAP message | O | TLV-E | 7-1503 |
| | | 9.11.2.2 | | | |

### *****END EXCERPT FROM 3GPP TS 24.501*****

### SUMMARY

Systems and methods are disclosed for supporting remote User Equipment (UE) authentication via a relay UE. In one embodiment, a method performed by a relay UE comprises receiving a first message conveyed by a remote UE and sending a second message to a relay access and mobility function (AMF), wherein the second message comprises a UE-to-Network (U2N) connection mapping identification (ID) that identifies the remote UE. In this manner, the relay UE and relay AMF are able to identify that the second message (e.g., an authentication related message) is for the remote UE.

In one embodiment, the second message further comprises a subscription concealed ID of the remote UE. In one embodiment, the second message further comprises: a relay service code received in the first message, a nonce received in the first message, or both a relay service code received in the first message and a nonce received in the first message.

In one embodiment, the second message is a relay key request.

In one embodiment, the first message is a direct communication request (DCR) message.

In one embodiment, the method further comprises receiving a first authentication message conveyed by the relay AMF, wherein the authentication message includes the U2N connection mapping ID that identifies the remote UE, and sending a second authentication message to the remote UE identified by the U2N connection mapping ID comprised in the first authentication message. In one embodiment, the first authentication message further comprises an extensible authentication protocol (EAP) message and/or one or more parameters, and the second authentication message comprises the EAP message and/or the one or more parameters. In one embodiment, the second authentication message is a PC5-S message. In one embodiment, the first authentication message is a relay authentication request.

In one embodiment, the method further comprises receiving a third authentication message conveyed by the remote UE and sending a fourth authentication message to the relay AMF, wherein the fourth authentication message comprises the U2N connection mapping ID that identifies the remote UE. In one embodiment, the third authentication message comprises an EAP message and/or one or more parameters, and the fourth authentication message comprises the EAP message and/or the one or more parameters. In one embodiment, the third authentication message is a PC5-S message.

In one embodiment, the method further comprises receiving a relay key response message conveyed by the relay AMF, wherein the relay key response comprises the U2N connection mapping ID that identifies the remote UE, and sending a message to the remote UE identified by the U2N connection mapping ID comprised in the relay key response message. In one embodiment, the relay key response message further comprises a 5GPRUK ID, a KNR_ProSe, and/or a Nonce_2, and the sent message comprises the 5GPRUK ID and/or the Nonce_2. In one embodiment, the method further comprises deriving a PC5 session key Krelay-sess and/or confidentiality and integrity keys from K_{NR_ProSe}. In one embodiment, the sent message is a direct security mode command.

In one embodiment, the method further comprises receiving a direct security complete message conveyed by the remote UE.

In one embodiment, the method further comprises assigning the U2N connection mapping ID to the remote UE.

In one embodiment, the U2N connection mapping ID is a temporary ID.

In one embodiment, the method further comprises storing a mapping between the U2N connection mapping ID and an ID of the remote UE. In one embodiment, the ID of the remote UE is a Layer-2 ID of the remote UE.

In one embodiment, the U2N connection mapping ID is a Layer-2 ID of the remote UE.

In one embodiment, the U2N connection mapping ID is a Generic Public Subscription Identifier (GPSI) of the remote UE.

In one embodiment, the U2N connection mapping ID is a User Info ID of the remote UE.

Corresponding embodiments of a relay UE are also disclosed. In one embodiment, a relay UE is adapted to receive a first message conveyed by a remote UE and send a second message to a relay AMF, wherein the second message comprises a U2N connection mapping ID that identifies the remote UE.

In one embodiment, a relay UE comprises communication circuitry and processing circuitry associated with the communication circuitry. The processing circuitry is configured to cause the relay UE to receive a first message conveyed by a remote UE and send a second message to a relay AMF, wherein the second message comprises a U2N connection mapping ID that identifies the remote UE.

Embodiments of a method performed by a relay AMF are also disclosed. In one embodiment, a method performed by a relay AMF comprises receiving a first message conveyed by a relay UE, wherein the first message comprises a U2N connection mapping ID that identifies a remote UE. The method further comprises selecting an authentication server function (AUSF), storing a mapping between the U2N connection mapping ID and an ID of the selected AUSF, and sending a second message to the selected AUSF.

In one embodiment, the first message further comprises a subscription concealed identifier of the remote UE. In one embodiment, the first message further comprises: a relay service code, a nonce, or both a relay service code and a nonce.

In one embodiment, the first message is a relay key request.

In one embodiment, the second message sent to the selected AUSF comprises: (a) a subscription concealed identifier of the remote UE, (b) a relay service code, (c) a nonce, or (d) a combination of any two or more of (a)-(d).

In one embodiment, the second message sent to the selected AUSF comprises a subscription concealed identifier of the remote UE, and selecting the AUSF comprises selecting the AUSF based on the subscription concealed ID of the remote UE.

In one embodiment, the message sent to the selected AUSF is a Nausf_UEAuthentication_Authenticate Request message.

In one embodiment, the method further comprises verifying that the relay UE is authorized to act as a U2N relay.

In one embodiment, the method further comprises sending a first authentication message to the relay UE, wherein the first authentication message comprises the U2N connection mapping ID. In one embodiment, the first authentication message further comprises an EAP message and/or one or more parameters.

In one embodiment, the method further comprises receiving a second authentication message conveyed by the relay UE, wherein the second authentication message comprises the U2N connection mapping ID, and sending a third authentication message to the AUSF mapped to the USN connection mapping ID comprised in the second authentication message. In one embodiment, the second authentication message further comprises an EAP message and/or one or more parameters, and the third authentication message comprises the EAP message and/or the one or more parameters comprised in the second authentication message. In one embodiment, sending the third authentication message to the AUSF comprises calling the Nausf_UEAuthentication service of the AUSF. In one embodiment, the method further comprises receiving an authentication response message conveyed by the AUSF, wherein the authentication response message comprises one or more parameters, and sending an authentication response message to the relay UE, wherein the authentication response message comprises the one or more parameters comprised in the received authentication response and the U2N connection mapping ID. In one embodiment, the sent authentication response message is a relay key response. In one embodiment, the one or more parameters comprised in the received authentication response comprise a 5GPRUK ID, a K_{NR_ProSe}, and/or a Nonce_2.

In one embodiment, the U2N connection mapping ID is a temporary ID.

In one embodiment, the U2N connection mapping ID is a Layer-2 ID of the remote UE.

In one embodiment, the U2N connection mapping ID is a GPSI of the remote UE.

In one embodiment, the U2N connection mapping ID is a User Info ID of the remote UE (302).

Corresponding embodiments of a relay AMF are also disclosed. In one embodiment, a relay AMF is adapted to receive a first message conveyed by a relay UE, wherein the first message comprises a U2N connection mapping ID that identifies a remote UE. The relay AMF is further adapted to select an AUSF, store a mapping between the U2N connection mapping ID and an ID of the selected AUSF, and send a second message to the selected AUSF.

In one embodiment, a relay AMF comprises a network interface and processing circuitry associated with the network interface. The processing circuitry is configured to cause the relay AMF to receive a first message conveyed by a relay UE, wherein the first message comprises a U2N connection mapping ID that identifies a remote UE. The processing circuitry is further configured to cause the relay AMF to select an AUSF, store a mapping between the U2N connection mapping ID and an ID of the selected AUSF, and send a second message to the selected AUSF.

### BRIEF DESCRIPTION OF THE DRAWINGS

The accompanying drawings, which are incorporated herein and form part of the specification, illustrate various aspects.

FIG. 1 illustrates a UE-to-Network Relay security procedure with setup of network Prose security context during PC5 link establishment.

FIG. 2 illustrates an EAP based primary authentication and key agreement procedure.

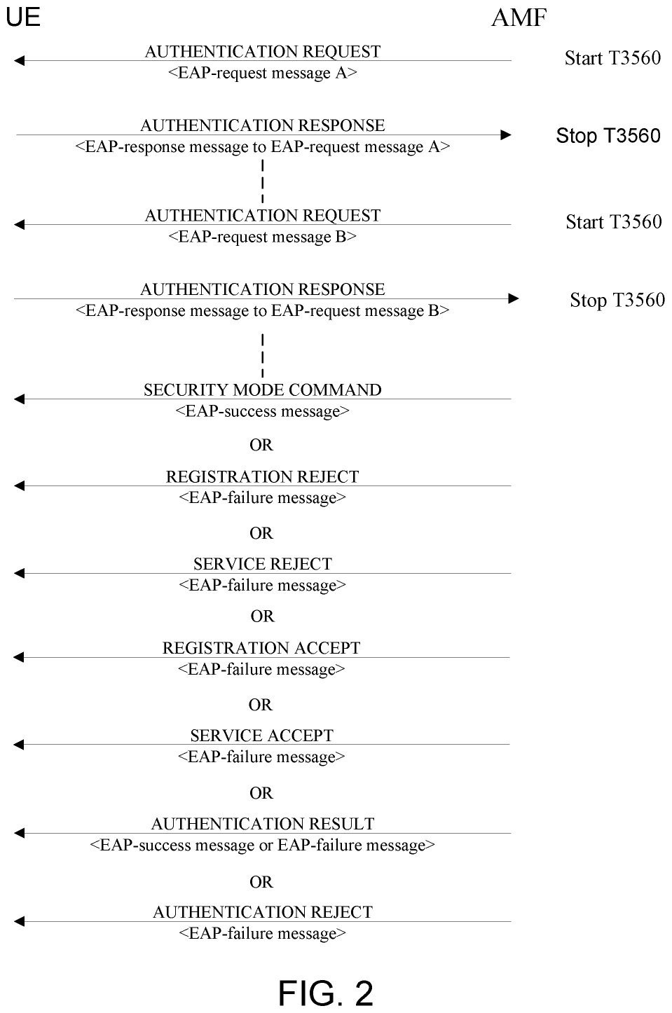

FIG. 3 illustrates a system and flowchart according to some aspects.

FIG. 4A is a flowchart illustrating a process according to some aspects.

FIG. 4B is a flowchart illustrating a process according to some aspects.

FIG. 5 is a flowchart illustrating a process according to some aspects.

FIG. 6 illustrates a user equipment according to some aspects.

FIG. 7 illustrates an apparatus according to some aspects.

### DETAILED DESCRIPTION

In this application, the term “node” can be a network node or a user equipment (UE). Examples of network nodes include, but are not limited to, a NodeB, a base station (BS), a multi-standard radio (MSR) radio node such as a MSR BS, an eNodeB, a gNodeB, a Master eNB (MeNB), a Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, remote radio unit (RRU), remote radio head (RRH), nodes in distributed antenna system (DAS), core network node (e.g. mobile switching center (MSC), mobile management entity (MME), etc.), operation and management (O&M), operation support systems (OSS), self-organizing network (SON), positioning node (e.g. evolved serving mobile location centre (E-SMLC)).

In this application, the term “user equipment” or “UE” is a non-limiting term that refers to any type of wireless device communicating with a network node and/or with another UE in a cellular or mobile communication system. Examples of UEs include, but are not limited to, a target device, a device to device (D2D) UE, a vehicular to vehicular (V2V), a machine type UE, a machine type communication (MTC) UE, a UE capable of machine to machine (M2M) communication, a PDA, a Tablet, a mobile terminal(s), a smart phone, laptop embedded equipment (LEE), laptop mounted equipment (LME), and USB dongles.

In this application, the terms “radio network node,” “network node,” and “NW node” is generic terminology that refers to any kind of network node including but not limited to a base station, a radio base station, a base transceiver station, a base station controller, a network controller, an evolved Node B (eNB), a Node B, a gNodeB (gNB), a relay node, an access point (AP), a radio access point, a Remote Radio Unit (RRU), a Remote Radio Head (RRH), a Central Unit (e.g. in a gNB), a Distributed Unit (e.g. in a gNB), a Baseband Unit, a Centralized Baseband, and a C-RAN.

In this application, the term “radio access technology” or “RAT” may refer to any RAT including, for example and without limitation, UTRA, E-UTRA, narrow band internet of things (NB-IoT), WiFi, Bluetooth, next generation RAT, New Radio (NR), 4G, and 5G. Any of the equipment denoted by the terms “node,” “network node,” or “radio network node” may be capable of supporting a single or multiple RATs.

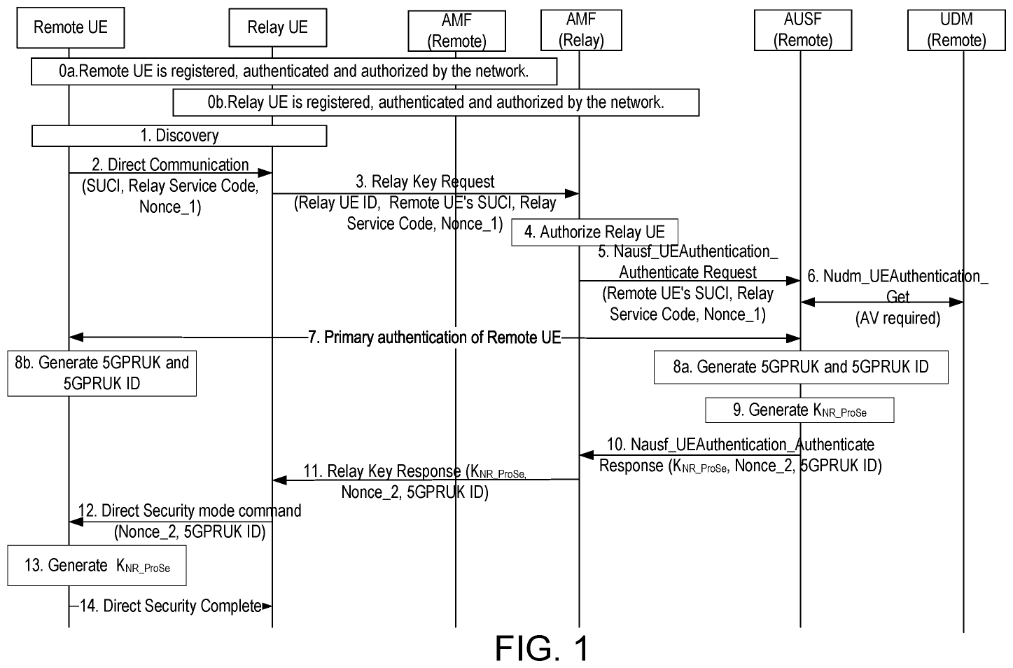

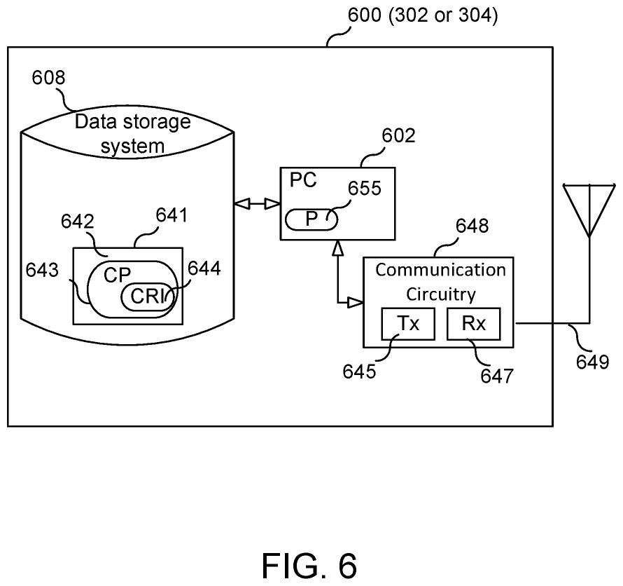

3^{rd} Generation Partnership Project (3GPP) Technical Specification (TS) 33.503 v0.2.0 clause 6.3.3.3.2 notes that further details on authentication message handling in UE, Relay UE's Access and Mobility Function (AMF), and Authentication Server Function (AUSF) are for further study. That is, 3GPP TS 33.503 v0.2.0 does not provide the details of step 7 of FIG. 6.3.3.3.2-1, which is reproduced herein in FIG. 1.

The existing authentication procedure is between a UE and the network (e.g., AMF). If the same authentication message as defined in 3GPP TS 24.501 is used, then, when the relay UE receives an authentication message from the AMF, the relay UE cannot tell whether the message is (a) for itself or (b) for a remote UE. In addition, if the message is for a remote UE, the relay UE cannot tell which remote UE the message is for. Similarly, when the relay UE forwards an authentication message from a remote UE to the AMF, the AMF does not know whether the message is (a) for the relay UE or (b) for a remote UE. In addition, if the message is for a remote UE, the AMF does not know which remote UE the message is for. Thus, the AMF does not know which AUSF the AMF needs to contact to proceed with the authentication procedure.

Aspects of the solution(s) disclosed herein may overcome one or more of the problems with the existing solution by having a relay UE use a UE-to-Network (U2N) connection mapping identification (ID) (e.g., a temporary ID) to identify the remote UE with the AMF. In some aspects, the relay UE may provide the U2N connection mapping ID to the AMF. In some aspects in which the U2N connection mapping ID is a temporary ID, the relay UE may assign a temporary ID for the remote UE and provide the temporary ID to the AMF. In some aspects, the relay UE may maintain a mapping between the remote UE L2 ID and the temporary ID. In some aspects, when the AMF sends an authentication message for a remote UE to the relay UE, the AMF may include the U2N connection mapping ID (e.g., the temporary ID) in the authentication message. In some aspects, the relay UE may use the U2N connection mapping ID in the message from the AMF to know which remote UE the authentication message is to. In some aspects, the AMF may maintain a mapping between the U2N connection mapping ID and the AUSF ID of the remote UE. In some aspects, the AMF may use the mapping to forward an Extensible Authentication Protocol (EAP) message to the correct AUSF.

In one embodiment, a relay UE may use a U2N connection mapping ID in an authentication message to identify a remote UE to which the authentication message is intended. The relay UE may include the U2N connection mapping ID in messages (e.g., authentication and/or relay key request messages) to a relay AMF. The relay AMF may store a mapping the U2N connection mapping ID an ID of an authentication server function (AUSF). The relay AMF may receive messages (e.g., authentication and/or authentication response messages) from the AUSF, use the mapping to select the U2N connection mapping ID, and include the U2N connection mapping ID in messages forwarded to the relay UE. The relay UE may receive an authentication message including the U2N connection mapping ID, use the U2N connection mapping ID to identify a remote UE, and send a PC5-S message to the remote UE.

Aspects of the solution(s) disclosed herein may provide the advantage of providing details on authentication message handling in UE, Relay UE's AMF, and AUSF with little impact to the current standard. Aspects of the solution(s) disclosed herein may additionally or alternatively provide the advantage of the relay UE and AMF being able to identify that an authentication is for a remote UE. In some aspects, in this way, a remote UE may be enabled to authenticate itself to the network via a relay UE. Aspects of the solution(s) disclosed herein may additionally or alternatively provide the advantage of enabling concurrent authentication of multiple remote UEs via the same relay UE.

One aspect of the solution(s) disclosed herein may provide a method performed by a relay UE. The method may include receiving a message conveyed by a remote UE. The method may include sending a message to a relay AMF. The sent message may include a U2N connection mapping ID that identifies the remote UE.

In some aspects, the message conveyed by the remote UE may be a Direct Communication Request (DCR) message. In some aspects, the message conveyed by the remote UE may include security capabilities of the remote UE, a security policy of the remote UE, a subscription concealed identifier (SUCI), a relay service code, and/or Nonce_1. In some aspects, the sent message including the U2N connection mapping ID may further include the ID of the remote UE, the SUCI, the relay service code, and/or the Nonce_1. In some aspects, the sent message including the U2N connection mapping ID may be a relay key request.

In some aspects, the method may further include receiving an authentication message conveyed by a relay AMF. The received authentication message may include the U2N connection mapping ID. In some aspects, the method may further include using the received U2N connection mapping ID to identify the remote UE. In some aspects, the method may further include sending an authentication message to the identified remote UE. In some aspects, the received authentication message may further include an extensible authentication protocol, EAP, message and/or one or more parameters, and the sent authentication message may include the EAP message and/or the one or more parameters. In some aspects, the sent authentication message may be a PC5-S message (e.g., a dedicated PC5-S message). In some aspects, the sent authentication message may include the U2N connection mapping ID. In some alternative aspects, the sent authentication message does not include the U2N connection mapping ID.

In some aspects, the method may further include receiving an authentication message conveyed by the remote UE, and the received authentication message may include the U2N connection mapping ID. In some aspects, the method may further include sending an authentication message to a relay AMF, and the sent authentication message may include the U2N connection mapping ID.

In some aspects, the method may further include receiving an authentication message conveyed by the remote UE, and the received authentication message does not include the U2N connection mapping ID. In some aspects, the method may further include sending an authentication message to a relay AMF, and the sent authentication message may include the U2N connection mapping ID.

In some aspects, the authentication message conveyed by the remote UE may include an EAP message and/or one or more parameters, and the authentication message sent to the relay AMF may include the EAP message and/or the one or more parameters. In some aspects, the received authentication message is a PC5-S message (e.g., a dedicated PC5-S message).

In some aspects, the method may further include receiving a relay key response message conveyed by a relay AMF, and the relay key response may include the U2N connection mapping ID. In some aspects, the method may further include using the received U2N connection mapping ID to identify the remote UE. In some aspects, the method may further include sending a message to the identified remote UE. In some aspects, the received relay key response message may further include a 5GPRUK ID, a KNR_ProSe, and/or a Nonce_2, and the sent message may include the 5GPRUK ID and/or the Nonce_2. In some aspects, the method may further include deriving a PC5 session key Krelay-sess and/or confidentiality and integrity keys from KNR_ProSe. In some aspects, the sent message may be a direct security mode command.

In some aspects, the method may further include receiving a direct security complete message conveyed by the remote UE.

In some aspects, the method may further include assigning the U2N connection mapping ID to the remote UE. In some aspects, the U2N connection mapping ID may be a temporary ID. In some aspects, the method may further include storing a mapping between the U2N connection mapping ID and an ID of the remote UE. In some aspects, the ID of the remote UE may be a Layer-2 ID of the remote UE.

In some aspects, the U2N connection mapping ID may be a Layer-2 ID of the remote UE. In some alternative aspects, the U2N connection mapping ID may be a Generic Public Subscription Identifier (GPSI) of the remote UE. In some alternative aspects, the U2N connection mapping ID may be a User Info ID of the remote UE.

Another aspect of the solution(s) disclosed herein may provide a relay user UE. The relay UE may be configured to receive a message conveyed by a remote UE. The relay UE may be configured to send a message to a relay AMF, and the sent message may include a U2N connection mapping ID that identifies the remote UE.

Still another aspect of the solution(s) disclosed herein may provide a method performed by a relay AMF. The method may include receiving a message conveyed by a relay UE, and the message may include a U2N connection mapping ID. The method may include selecting an AUSF. The method may include storing a mapping between the U2N connection mapping ID and an ID of the selected AUSF. The method may include sending a message to the selected AUSF.

In some aspects, the message conveyed by the relay UE may be a relay key request.

In some aspects, the message conveyed by the relay UE may further include an ID of a remote UE, a SUCI of the remote UE, a relay service code, and/or Nonce_1. In some aspects, the ID of the remote UE may be a Layer-2 ID of the remote UE. In some aspects, the message sent to the selected AUSF may include the SUCI of the remote UE, the relay service code, and/or the Nonce_1. In some aspects, the AUSF may be selected based on the SUCI of the remote UE.

In some aspects, the message sent to the selected AUSF may be a Nausf_UEAuthentication_Authenticate Request message. In some aspects, the method may further include verifying that the relay UE is authorized to act as a U2N relay.

In some aspects, the method may further include sending an authentication message to the relay UE, and the authentication message may include the U2N connection mapping ID. In some aspects, the authentication message may further include an extensible authentication protocol, EAP, message and/or one or more parameters.

In some aspects, the method may further include receiving an authentication message conveyed by the relay UE, and the received authentication message may include the U2N connection mapping ID. In some aspects, the method may further include using the received U2N connection mapping ID and the mapping to identify the selected AUSF. In some aspects, the method may further include sending an authentication message to the identified AUSF. In some aspects, the received authentication message may further include an EAP message and/or one or more parameters, and the sent authentication message may include the EAP message and/or the one or more parameters. In some aspects, sending the authentication message to the identified AUSF may include calling the Nausf_UEAuthentication service of the identified AUSF.

In some aspects, the method may further include receiving an authentication response message conveyed by the AUSF, and the authentication response message may include one or more parameters. In some aspects, the method may further include using the mapping to select the U2N connection mapping ID. In some aspects, the method may further include sending an authentication response message to the relay UE, and the authentication response message may include the one or more parameters and the selected U2N connection mapping ID. In some aspects, the sent authentication response message may be a relay key response. In some aspects, the one or more parameters may include a 5GPRUK ID, a KNR_ProSe, and/or a Nonce_2.

In some aspects, the U2N connection mapping ID may be a temporary ID. In some alternative aspects, the U2N connection mapping ID may be a Layer-2 ID of a remote UE. In some alternative aspects, the U2N connection mapping ID may be a GPSI of a remote UE. In some alternative aspects, the U2N connection mapping ID may be a User Info ID of a remote UE.

Yet another aspect of the invention may provide a relay AMF. The relay AMF may be configured to receive a message conveyed by a relay UE, and the message may include a U2N connection mapping ID. The relay AMF may be configured to select an AUSF. The relay AMF may be configured to store a mapping between the U2N connection mapping ID and an ID of the selected AUSF. The relay AMF may be configured to send a message to the selected AUSF.

Still another aspect of the solution(s) described herein may provide a method performed by a relay UE. The method may include receiving an authentication message conveyed by a relay AMF, and the received authentication message may include an EAP message and/or one or more parameters. The method may include sending a PC5-S message to a remote UE, and the PC5-S message may include the EAP message and/or the one or more parameters.

In some aspects, the received authentication message may include a U2N connection mapping ID, and the method may further include using the U2N connection mapping ID to identify the remote UE. In some aspects, the sent authentication message may include the U2N connection mapping ID. In some alternative aspects, the sent authentication message does not include the U2N connection mapping ID.

In some aspects, the method may further include receiving a DCR message conveyed by the remote UE.

In some aspects, the method may further include sending a relay key request including the U2N connection mapping ID. In some aspects, the DCR message may include security capabilities of the remote UE, a security policy of the remote UE, a SUCI, a relay service code, and/or Nonce_1. In some aspects, the relay key request may further include the ID of the remote UE, the SUCI, the relay service code, and/or the Nonce_1.

In some aspects, the method may further include assigning the U2N connection mapping ID to the remote UE. In some aspects, the method may further include storing the mapping between the U2N connection mapping ID and the ID of the remote UE. In some aspects, using the U2N connection mapping ID to identify the remote UE may include using the U2N connection mapping ID and the mapping to identify the remote UE. In some aspects, the ID of the remote UE may be a Layer-2 ID of the remote UE.

In some aspects, the method may further include receiving an authentication message conveyed by the remote UE, and the received authentication message may include the U2N connection mapping ID. In some aspects, the method may further include sending an authentication message to the relay AMF, and the sent authentication message may include the U2N connection mapping ID. In some alternative aspects, the method may further include receiving an authentication message conveyed by the remote UE, and the received authentication message does not include the U2N connection mapping ID. In some aspects, the method may further include identifying the U2N connection mapping ID and sending an authentication message to the relay AMF, and the sent authentication message may include the identified U2N connection mapping ID.

In some aspects, the authentication message conveyed by the remote UE may include an EAP message and/or one or more parameters, and the authentication message sent to the relay AMF may include the EAP message and/or the one or more parameters. In some aspects, the received authentication message may be a PC5-S message (e.g., a dedicated PC5-S message).

In some aspects, the method may further include receiving a relay key response message conveyed by the relay AMF, and the relay key response may include the U2N connection mapping ID. In some aspects, the method may further include using the received U2N connection mapping ID to identify the remote UE. In some aspects, the method may further include sending a direct security mode command to the identified remote UE. In some aspects, the received relay key response message may further include a 5GPRUK ID, a KNR_ProSe, and/or a Nonce_2, and the direct security mode command may include the 5GPRUK ID and/or the Nonce_2. In some aspects, the method may further include deriving a PC5 session key Krelay-sess and/or confidentiality and integrity keys from KNR_ProSe.

In some aspects, the U2N connection mapping ID may be a temporary ID. In some alternative aspects, the U2N connection mapping ID may be a Layer-2 ID of the remote UE. In some alternative aspects, the U2N connection mapping ID may be a GPSI of the remote UE. In some alternative aspects, the U2N connection mapping ID may be a User Info ID of the remote UE

In some aspects, the method may further include receiving a direct security complete message conveyed by the remote UE. In some aspects, the PC5-S message is a dedicated PC5-S message.

Yet another aspect of the solution(s) described herein may provide a relay UE. The relay UE may be configured to receive an authentication message conveyed by a relay AMF. The relay UE may be configured to send an authentication message to a remote UE, and the sent authentication message may be a PC5-S message.

Yet another aspect of the solution(s) described herein may provide a computer program including instructions for adapting an apparatus to perform any of the methods set forth above. Still another aspect of the invention may provide a carrier containing the computer program, and the carrier may be one of an electronic signal, optical signal, radio signal, or compute readable storage medium.

Still another aspect of the solution(s) described herein may provide an apparatus including processing circuitry and a memory. The memory containing instructions executable by the processing circuitry, whereby the apparatus is operative to perform any of the methods set forth above.

Yet another aspect of the solution(s) described herein may provide an apparatus adapted to any of the methods set forth above.

Still another aspect of the solution(s) described herein may provide any combination of the aspects set forth above.

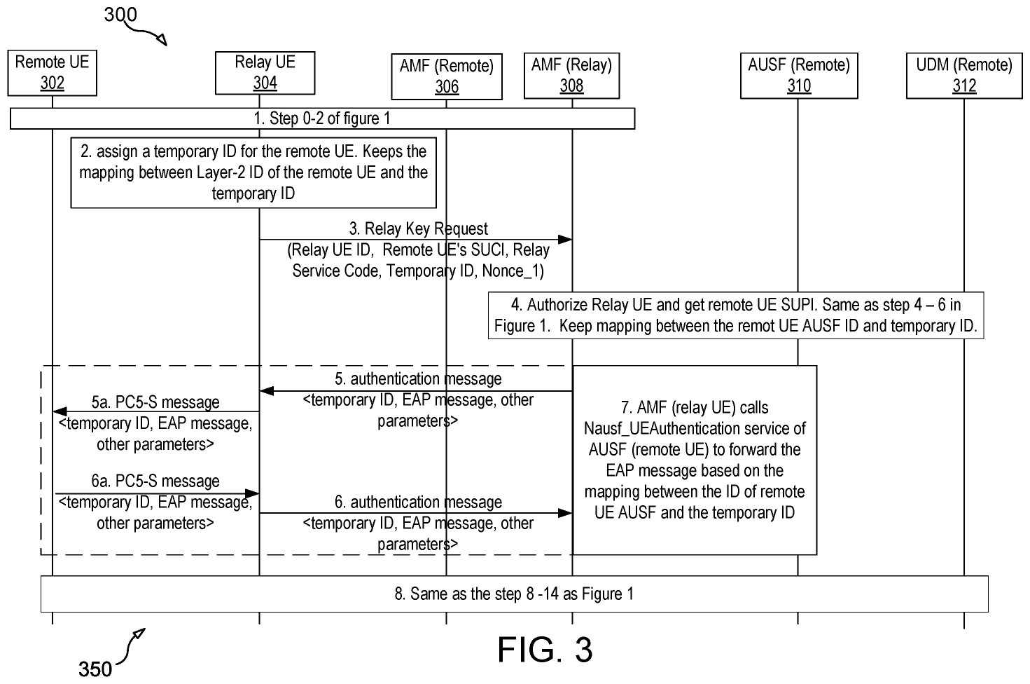

FIG. 3 illustrates a system 300 according to some aspects. In some aspects, as shown in FIG. 3, the system 300 may include one or more nodes. In some aspects, the nodes of the system 300 may include a remote UE 302, a relay UE 304, a remote AMF 306, a relay AMF 308, an AUSF 310 (e.g., a remote AUSF), and/or a Unified Data Management (UDM) 310. In some aspects, the system 300 may perform a process 350.

In some aspects, the process 350 may include a step 1, which may include one or more of steps 0-2 as shown in FIG. 1 and described in 3GPP TS 33.503 v0.2.0 clause 6.3.3.3.2. That is, in some aspects, step 1 of the process 350 may include the remote UE 302 and/or the relay UE 304 being registered with the network, as shown in steps 0a and/or 0b of FIG. 1 and/or described in step 0 of 3GPP TS 33.503 v0.2.0 clause 6.3.3.3.2. In some aspects, the UE-to-Network relay (e.g., relay UE 304) may be authenticated and authorized by the network to support as a relay UE. In some aspects, the remote UE 302 shall be authenticated and authorized by the network to act as a remote UE. In some aspects, step 1 of the process 350 may additionally or alternatively include the remote UE 302 initiating a discovery procedure (e.g., using any of the Model A or Model B method as specified in clause 6.3.1.2 or 6.3.1.3 of TS 23.304, respectively), as shown in step 1 of FIG. 1 and/or described in step 1 of 3GPP TS 33.503 v0.2.0 clause 6.3.3.3.2. In some aspects, step 1 of the process 350 may include, after the discovery of the UE-to-Network relay, the remote UE 302 sending a direct communication request (DCR) message to the relay UE 304 for establishing secure PC5 unicast link, as shown in step 2 of FIG. 1 and/or described in steps 2-5 of 3GPP TS 33.503 v0.2.0 clause 6.3.3.3.2. In some aspects, the remote UE 302 may include in the DCR message the security capabilities and/or security policy of the remote UE 302 (e.g., as specified in 3GPP TS 33.536). In some aspects, the DCR message may additionally or alternatively include a subscription concealed identifier (SUCI), a Relay Service Code, and/or Nonce_1.

In some aspects, the process 350 may include a step 2 in which the relay UE 304, upon receiving the DCR message, assigns a temporary ID for the remote UE 302. In some aspects, the relay UE 102 may keep a mapping between the temporary ID and an ID of the remote UE 302 (e.g., the Layer-2 ID of the remote UE 302).

In some aspects, the process 350 may include a step 3 in which the relay UE 304 sends a relay key request to the relay AMF 308 and in which the relay AMF 308 receives the relay key request. In some aspects, the relay key request may include the temporary ID, the ID of the remote UE 302 (e.g., the Layer-2 ID of the remote UE 302), and/or one or more of the parameters (e.g., the SUCI of the remote UE 302, the Relay Service Code, and/or the Nonce_1) received in the DCR message.

In some aspects, the process 350 may include a step 4 in which the relay AMF 308 verifies whether the relay UE 304 is authorized to act as UE-to-Network (U2N) relay. In some aspects, in step 4, the relay AMF 308 may select an AUSF 310 based on the SUCI of the remote UE 302, which may be received in the relay key request in step 3. For example, in some aspects, the relay AMF 308 may selected an AUSF 310 based on the routing indicator in the SUCI of the remote UE 302. In some aspects, the relay AMF 308 may maintain a mapping between the temporary ID (e.g., the temporary ID received in relay key request in step 3) and an ID of the AUSF 310 selected for the remote UE 302. In some aspects, in step 4, the relay AMF 308 may forward the relay key request to the selected AUSF 310 in an Nausf_UEAuthentication_Authenticate Request message. In some aspects, the Nausf_UEAuthentication_Authenticate Request message may include the ID of the remote UE 302 (e.g., the Layer-2 ID of the remote UE 302) and/or one or more of the parameters (e.g., the SUCI of the remote UE 302, the Relay Service Code, and/or the Nonce_1) that the relay UE 304 received in the DCR message.

In some aspects, in step 4, the AUSF 310 may receive the forwarded relay key request. In some aspects, in step 4, the AUSF 310 may retrieve the Authentication Vectors from the UDM 312 (e.g., using a Nudm_UEAuthentication_Get message. In some aspects, in step 4, the AUSF 310 may trigger primary authentication of the remote UE 302 (e.g., using the existing procedure as specified in 3GPP TS 33.501).

In some aspects, the step 4 of the process 350 may be similar to steps 4-6 as shown in FIG. 1 and described in 3GPP TS 33.503 v0.2.0 clause 6.3.3.3.2 with the relay AMF 308 additionally maintaining the mapping between the temporary ID and the AUSF ID. In some aspects, the relay AMF 308 may subsequently use the mapping to forward an EAP message to the correct AUSF 310.

In some aspects, the process 350 may include steps 5 and 6 in which the remote UE 302 and the relay AMF 308 exchange authentication messages via the relay UE 304. That is, in some aspects, the process 350 may include a step 5 in which the relay AMF 308 sends an authentication message to the remote UE 302 via the relay UE 304. In some aspects, the authentication message may be, for example, an authentication request, reject, failure, or result message. In some aspects, the authentication message sent by the relay AMF 308 and received by the relay UE 304 in step 5 may include the temporary ID, an EAP message, and/or one or more parameters. In some aspects, the relay UE 304 may use the temporary ID and the mapping to identify the remote UE 302 to which the authentication message should be forwarded.

In some aspects, step 5 may include a step 5a in which the relay UE 304 forwards an authentication message to the remote UE 302 identified by the temporary ID and the mapping. In some aspects, the relay UE 304 may use a PC5-S message (e.g., a dedicated PC5-S message) to forward the authentication message to the remote UE 302. In some aspects, the relay UE 304 may determine the destination Layer-2 ID of the PC5-S message according to the mapping between the Layer-2 ID of the remote UE 302 and the temporary ID. In some aspects, the authentication message forwarded by the relay UE 304 to the remote UE 302 may include the EAP message and/or the one or more parameters. In some aspects, the authentication message forwarded by the relay UE 304 to the remote UE 302 may additionally include the temporary ID. In some alternative aspects, the relay UE 304 may remove the temporary ID from the authentication message forwarded by the relay UE 304 to the remote UE 302. In some aspects, in step 5, the remote UE 302 may receive the authentication message forwarded by the relay UE 304.

In some aspects, the process 350 may include the step 6 in which the remote UE 302 sends an authentication message to the relay AMF 308 via the relay UE 304. In some aspects, the authentication message may be, for example, an authentication request, reject, failure, or result message. In some aspects, the step 6 may include a step 6a in which the remote UE 302 sends and the relay UE 304 receives an authentication message. In some aspects, the remote UE 302 may use a PC5-S message (e.g., a dedicated PC5-S message) to send the authentication message to the relay 304. In some aspects, the authentication message sent by the remote UE 302 and received by the relay UE 304 in step 6a may include an EAP message and/or one or more parameters. In some aspects, if the authentication message received by the remote UE 302 in step 5a includes the temporary ID, the remote UE 302 may include the temporary ID in the authentication message sent by the remote UE 302 and received by the relay UE 304 in step 6a.

In some aspects, step 6 may include the relay UE 304 forwarding an authentication message to the relay AMF 308. In some aspects, the authentication message forwarded by the relay UE 304 to the relay AMF 308 may include the EAP message and/or the one or more parameters. In some aspects, the authentication message forwarded by the relay UE 304 to the remote UE 302 may additionally include the temporary ID. In some aspects, if the authentication message sent by the remote UE 302 and received by the relay UE 304 in step 6 includes a temporary ID (e.g., the temporary ID included in the authentication message received by the remote UE 302 in step 5), the authentication message forwarded by the relay UE 304 to the relay AMF 308 may include the temporary ID in the authentication message sent by the remote UE 302 and received by the relay UE 304 in step 6. In some aspects, if the authentication message sent by the remote UE 302 and received by the relay UE 304 in step 6 does not include a temporary ID (e.g., because the relay UE 304 removed the temporary ID from the authentication message forwarded to the remote UE 302 in step 5), the relay UE 304 may add the temporary ID assigned for the remote UE 302 (e.g., the temporary ID assigned for the remote UE 302 in step 2). In aspects, in step 6, the relay AMF 308 may receive the authentication message forwarded by the relay UE 304.

In some aspects, the authentication messages exchanged in steps 5 and 6 may be message defined in 3GPP TS 24.501 (e.g., AUTHENTICATION REQUEST, AUTHENTICATION RESPONSE, AUTHENTICATION REJECT, AUTHENTICATION FAILURE, or AUTHENTICATION RESULT). In some alternative aspects, the authentication messages exchanged in steps 5 and 6 may be new types of messages (e.g., remote UE authentication request, response, reject, failure, or result).

In some aspects, the process 350 may include a step 7 in which the relay AMF 308 forwards the EAP message (e.g., the EAP message of the authentication message received by the relay AMF 308 in step 6) to the AUSF 310. In some aspects, the relay AMF 308 may use the temporary ID in the authentication message received in step 6 and the mapping between the temporary ID and AUSF ID to identify the correct AUSF 310 to which the EAP message should be forwarded. In some aspects, the relay AMF 308 may call the Nausf_UEAuthentication service of the AUSF 310 to forward the EAP message (e.g., based on the mapping between the temporary ID and the ID of the AUSF 310 selected for the remote UE 302). In some aspects, in step 7, the AUSF 310 may receive the EAP message.

In some aspects, the process 350 may include a step 8, which may include one or more steps similar to steps 8-14 as shown in FIG. 1 and described in 3GPP TS 33.503 v0.2.0 clause 6.3.3.3.2 with the relay AMF 308 including the temporary ID in the relay key response message sent to the relay UE 304. That is, in some aspects, step 8 of the process 350 may include, on successful primary authentication (e.g., in steps 5-7 of the process 350), the AUSF 310 and remote UE 102 may generate 5GPRUK (e.g., as specified in Annex A.2 of 3GPP TS 33.503) and 5GPRUK ID (e.g., as specified in Annex A.3 of 3GPP TS 33.503) using the newly derived KAUSF. In some aspects, step 8 of the process 350 may include the AUSF 310 generating the K_{NR_ProSe} key (e.g., as defined in Annex A.4 of 3GPP TS 33.503). In some aspects, step 8 of the process 350 may include the AUSF 310 sending the 5GPRUK ID, K_{NR_ProSe}, and/or Nonce_2 in a Nausf_UEAuthentication_Authenticate Response message to the UE-to-Network relay via the relay AMF 308.

In some aspects, the relay AMF 308 may receive the 5GPRUK ID, K_{NR_ProSe}, and/or Nonce_2 (e.g., in the Nausf_UEAuthentication_Authenticate Response message) and send a relay key response to the relay UE 304. In some aspects, the relay AMF 308 may include the temporary ID in the relay key response. In some aspects, the relay AMF 308 may select the temporary ID for inclusion in the relay key response based on the mapping between the temporary ID and the ID of the AUSF 310, which was selected for the remote UE 302 and sent the message including the 5GPRUK ID, K_{NR_ProSe}, and/or Nonce_2. In some aspects, when receiving a K_{NR_ProSe} from the AUSF 310, the relay AMF 308 may not attempt to trigger a NAS SMC procedure with the remote UE 302. In some aspects, the relay UE 304 may derive a PC5 session key Krelay-sess and confidentiality and integrity keys from K_{NR_ProSe}, using the KDF (e.g., as defined in clause 6.3.3.3.4 of 3GPP TS 33.503). In some aspects, the K_{NR_ProSe} ID and Krelay-sess ID may be established in the same way as KNRP ID and KNRP-sess ID in TS 33.536.

In some aspects, step 8 of the process 350 may include the relay UE 304 receiving the relay key response (e.g., including the 5GPRUK ID, K_{NR_ProSe}, Nonce_2, and/or temporary ID) from the relay AMF 308. In some aspects, the UE-to-Network relay (e.g., the relay UE 304) may send the received 5GPRUK ID and/or Nonce_2 to the remote UE 302 (e.g., in a Direct Security mode command message). In some aspects, the relay UE 304 may identify the remote UE 302 to send the 5GPRUK ID and/or Nonce_2 using the received temporary ID and the mapping between temporary IDs and remote UE IDs. In some aspects, the relay UE 304 may include the received temporary ID in the Direct Security mode command message to the remote UE 302. However, this is not required, and, in some alternative aspects, the relay UE 304 may include the received temporary ID in the Direct Security mode command message to the remote UE 302.

In some aspects, step 8 of the process 350 may include the remote UE 302 using the 5GPRUK ID (e.g., received in the Direct Security mode command message) to locate the KAUSF and/or 5GPRUK to be used for the PC5 link security. In some aspects, the remote UE 302 may generate the K_{NR_ProSe} key to be used for remote access via the relay UE 304 in the same way described above. In some aspects, the remote UE 302 may derive the PC5 session key Krelay-sess and confidentiality and integrity keys from K_{NR_ProSe} in the same way as defined above. In some aspects, the remote UE 302 may send the Direct Security mode complete message to the UE-to-Network relay.

In some aspects, the process 350 may include the relay UE 304 removing or discarding the temporary ID after the remote UE 302 finishes its authentication procedure.

In some aspects, the temporary ID may be used as a UE-to-Network (U2N) connection mapping identification (ID). In some alternative aspects, instead of a temporary ID assigned by the relay UE 304 in step 2 of the process 350, an existing ID of the remote UE 302 (e.g., the Layer-2 ID of the remote UE 302, a Generic Public Subscription Identifier (GPSI) of the remote UE 302, the User Info ID of the remote UE 302 from the application layer).

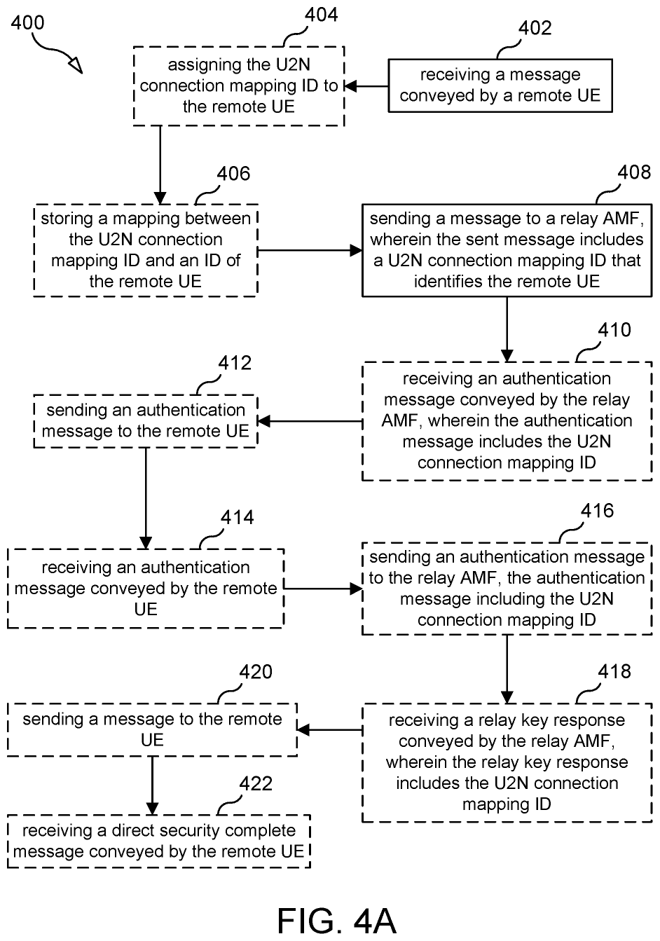

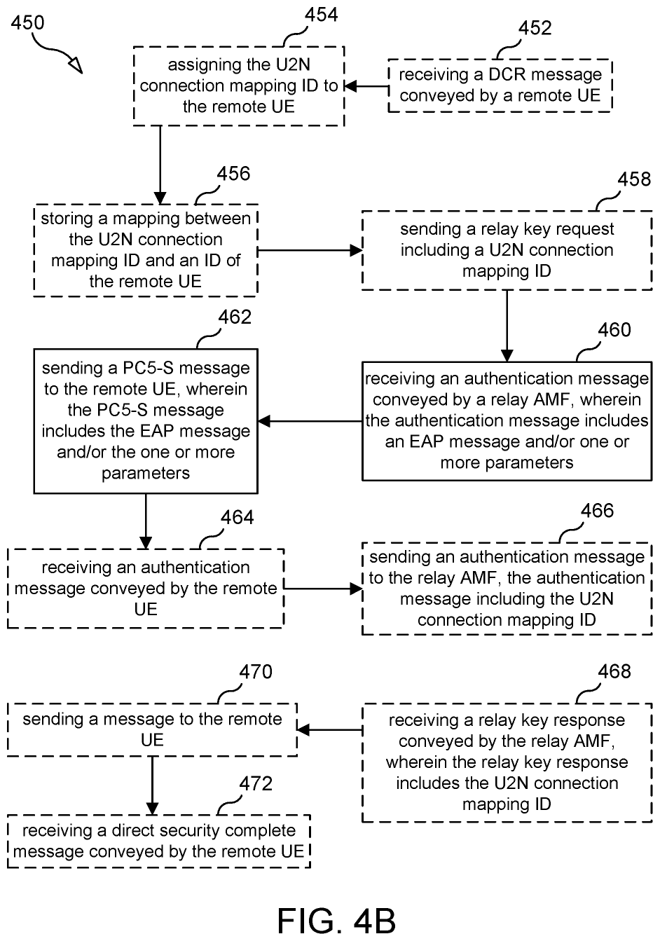

FIG. 4A illustrates a process 400 performed by a relay UE 302 according to some aspects. In some aspects, as shown in FIG. 4A, the process 400 may include a step 402 in which the relay UE 304 receives a message conveyed by a remote UE 302.

In some aspects, as shown in FIG. 4A, the process 400 may include a step 408 in which the relay UE 304 sends a message to a relay access and mobility function (AMF) 308. The sent message may include a UE-to-Network (U2N) connection mapping identification (ID) that identifies the remote UE 302.

In some aspects, as shown in FIG. 4A, the process 400 may include an optional step 404 in which the relay UE 304 assigns the U2N connection mapping ID to the remote UE 302. In some aspects, the U2N connection mapping ID may be a temporary ID. In some aspects, as shown in FIG. 4A, the process 400 may include an optional step 406 in which the relay UE 304 stores a mapping between the U2N connection mapping ID and an ID of the remote UE 302. In some aspects, the ID of the remote UE 302 may be a Layer-2 ID of the remote UE 302. In some alternative aspects, the U2N connection mapping ID may be a Layer-2 ID of the remote UE 302. In some other alternative aspects, the U2N connection mapping ID may be a Generic Public Subscription Identifier (GPSI) of the remote UE 302. In some further alternative aspects, the U2N connection mapping ID may be a User Info ID of the remote UE 302 (e.g., from the application layer). In some aspects (e.g., in some aspects in which the U2N connection mapping ID is a Layer-2 ID of the remote UE 302), the process 400 may not include steps 404 and 406. In some alternative aspects (e.g., in some aspects in which the U2N connection mapping ID is a GPSI or User Info ID of the remote UE 302), the process 450 may not include step 404 but may include step 406, and the mapping may be between the GPSI or User Info ID of the remote UE 302 and a Layer-2 ID of the remote UE 302.

In some aspects, the message conveyed by the remote UE 302 and received by the relay UE 304 in step 408 may be a direct communication request (DCR) message. In some aspects, the message conveyed by the remote UE 302 and received by the relay UE 304 in step 408 may include security capabilities of the remote UE 302, a security policy of the remote UE 302, a subscription concealed identifier (SUCI), a relay service code, and/or Nonce_1. In some aspects, the message sent to the relay AMF 308 in step 408, which includes the U2N connection mapping ID, may further include the ID of the remote UE 302, the SUCI, the relay service code, and/or the Nonce_1. In some aspects, the message sent to the relay AMF 308 in step 408, which includes the U2N connection mapping ID, may be a relay key request.

In some aspects, as shown in FIG. 4A, the process 400 may include an optional step 410 in which the relay UE 304 receives an authentication message conveyed by the relay AMF 308. In some aspects, the received authentication message may include the U2N connection mapping ID. In some aspects, the optional step 410 may further include using the received U2N connection mapping ID to identify the remote UE 302. In some aspects, the remote UE 302 may be identified using a stored mapping between the between the U2N connection mapping ID and an ID of the remote UE 302 (e.g., if the relay UE 304 assigns a temporary ID to the remote UE 302) or using the U2N connection mapping ID itself (e.g., if the U2N connection mapping ID is a Layer-2 ID, a GPSI, or a User Info ID of the remote UE 302).

In some aspects, as shown in FIG. 4A, the process 400 may include an optional step 412 in which the relay UE 304 sends an authentication message to the remote UE 302 identified in step 410. In some aspects, the authentication message received in step 410 may further include an extensible authentication protocol (EAP) message and/or one or more parameters, and the authentication message sent in step 412 may include the EAP message and/or the one or more parameters. In some aspects, the authentication message sent in step 412 may be a PC5-S message (e.g., a dedicated PC5-S message). In some aspects, the authentication message sent in step 412 may include the U2N connection mapping ID. In some alternative aspects, the authentication message sent in step 412 does not include the U2N connection mapping ID.

In some aspects, as shown in FIG. 4A, the process 400 may include an optional step 414 in which the relay UE 304 receives an authentication message conveyed by the remote UE 302. In some aspects, the authentication message received in step 414 may include the U2N connection mapping ID. In some alternative aspects, the authentication message received in step 414 does not include the U2N connection mapping ID. In some aspects in which the authentication message received in step 414 does not include the U2N connection mapping ID, the step 414 may include identifying the U2N connection mapping ID (e.g., using a stored mapping between the between the U2N connection mapping ID and an ID of the remote UE 302). In some aspects, as shown in FIG. 4A, the process 400 may include an optional step 416 in which the relay UE 304 sends an authentication message to a relay access and mobility function (AMF) 308, and the authentication message sent in step 416 may include the U2N connection mapping ID. In some aspects, the authentication message conveyed by the remote UE 302 and received by the relay UE 304 in step 414 may include an extensible authentication protocol (EAP) message and/or one or more parameters, and the authentication message sent to the relay AMF 308 in step 416 may include the EAP message and/or the one or more parameters. In some aspects, the authentication message received in step 414 may include a PC5-S message (e.g., a dedicated PC5-S message).

In some aspects, as shown in FIG. 4A, the process 400 may include an optional step 418 in which the relay UE 304 receives a relay key response message conveyed by a relay AMF 308, and the relay key response may include the U2N connection mapping ID. In some aspects, the step 418 may further include using the received U2N connection mapping ID to identify the remote UE 302. In some aspects, the relay UE 308 may identify the remote UE 302 using a stored mapping between the between the U2N connection mapping ID and an ID of the remote UE 302 (e.g., if the relay UE 304 assigns a temporary ID to the remote UE 302) or using the U2N connection mapping ID itself (e.g., if the U2N connection mapping ID is a Layer-2 ID, a GPSI, or a User Info ID of the remote UE 302).

In some aspects, as shown in FIG. 4A, the process 400 may include an optional step 420 in which the relay UE 304 sends a message to the identified remote UE 302. In some aspects, the relay key response message received in step 418 may further include a 5GPRUK ID, a KNR_ProSe, and/or a Nonce_2, and the message sent in step 420 may include the 5GPRUK ID and/or the Nonce_2. In some aspects, the process 400 further include deriving a PC5 session key Krelay-sess and/or confidentiality and integrity keys from KNR_ProSe. In some aspects, the message sent in step 420 may be a direct security mode command.

In some aspects, as shown in FIG. 4A, the process 400 may include an optional step 422 in which the relay UE 304 receives a direct security complete message conveyed by the remote UE 302.

FIG. 4B illustrates a process 450 performed by a relay UE 302 according to some aspects. In some aspects, as shown in FIG. 4B, the process 450 may include an optional step 452 in which the relay UE 304 receives a direct communication request (DCR) message conveyed by a remote UE 302.

In some aspects, as shown in FIG. 4B, the process 450 may include an optional step 458 in which the relay UE 304 sends a relay key request including a U2N connection mapping ID. In some aspects, the DCR message received in step 452 may include security capabilities of the remote UE 302, a security policy of the remote UE 302, a subscription concealed identifier (SUCI), a relay service code, and/or Nonce_1. In some aspects, the relay key request sent in step 458 may further include the ID of the remote UE 302, the SUCI, the relay service code, and/or the Nonce_1.

In some aspects, as shown in FIG. 4B, the process 450 may include an optional step 454 in which the relay UE 304 assigns the U2N connection mapping ID to the remote UE 302. In some aspects, the U2N connection mapping ID may be a temporary ID. In some aspects, as shown in FIG. 4B, the process 450 may include an optional step 456 in which the relay UE 304 stores a mapping between the U2N connection mapping ID and an ID of the remote UE 302. In some aspects, the ID of the remote UE 302 may be a Layer-2 ID of the remote UE 302. In some alternative aspects, the U2N connection mapping ID may be a Layer-2 ID of the remote UE 302. In some other alternative aspects, the U2N connection mapping ID may be a Generic Public Subscription Identifier (GPSI) of the remote UE 302. In some further alternative aspects, the U2N connection mapping ID may be a User Info ID of the remote UE 302 (e.g., from the application layer). In some aspects (e.g., in some aspects in which the U2N connection mapping ID is a Layer-2 ID of the remote UE 302), the process 450 may not include steps 454 and 456. In some alternative aspects (e.g., in some aspects in which the U2N connection mapping ID is a GPSI or User Info ID of the remote UE 302), the process 450 may not include step 454 but may include step 456, and the stored mapping may be between, for example, the GPSI or User Info ID of the remote UE 302 and a Layer-2 ID of the remote UE 302.

In some aspects, as shown in FIG. 4B, the process 450 may include a step 460 in which the relay UE 304 receives an authentication message conveyed by the relay AMF 308, and the received authentication message may include an EAP message and/or one or more parameters. In some aspects, the authentication message received in step 460 may include a UE-to-Network (U2N) connection mapping identification (ID), and the step 460 may further include using the U2N connection mapping ID to identify the remote UE 302. In some aspects, the relay UE 304 may identify the remote UE 302 in step 460 using a stored mapping between the between the U2N connection mapping ID and an ID of the remote UE 302 (e.g., if the relay UE 304 assigns a temporary ID to the remote UE 302) or using the U2N connection mapping ID itself (e.g., if the U2N connection mapping ID is a Layer-2 ID, a GPSI, or a User Info ID of the remote UE 302).

In some aspects, as shown in FIG. 4B, the process 450 may include a step 462 in which the relay UE 304 sends a PC5-S message to a remote UE 302, and the PC5-S message may include the EAP message and/or the one or more parameters. In some aspects, the PC5-S message is a dedicated PC5-S message. In some aspects, the authentication message sent in step 462 may include the U2N connection mapping ID. In some alternative aspects, the authentication message sent in step 462 does not include the U2N connection mapping ID.

In some aspects, as shown in FIG. 4B, the process 450 may include an optional step 464 in which the relay UE 304 receives an authentication message conveyed by the remote UE 302. In some aspects, the received authentication message may include the U2N connection mapping ID. In some alternative aspects, the received authentication message does not include the U2N connection mapping ID. In some aspects in which the authentication message received in step 414 does not include the U2N connection mapping ID, the step 414 may include identifying the U2N connection mapping ID (e.g., using a stored mapping between the between the U2N connection mapping ID and an ID of the remote UE 302).

In some aspects, as shown in FIG. 4B, the process 450 may include an optional step 466 in which the relay UE 304 sends an authentication message to the relay AMF 308, and the sent authentication message may include the U2N connection mapping ID. In some aspects, the authentication message conveyed by the remote UE 302 and received by the relay UE 304 in step 464 may include an EAP message and/or one or more parameters, and the authentication message sent to the relay AMF 308 in step 466 may include the EAP message and/or the one or more parameters. In some aspects, the authentication message received in step 464 may be a PC5-S message (e.g., a dedicated PC5-S message).

In some aspects, as shown in FIG. 4B, the process 450 may include an optional step 468 in which the relay UE 304 receives a relay key response message conveyed by the relay AMF 308, and the relay key response may include the U2N connection mapping ID. In some aspects, the step 468 may further include using the received U2N connection mapping ID to identify the remote UE 302. In some aspects, the relay UE 308 may identify the remote UE 302 using a stored mapping between the between the U2N connection mapping ID and an ID of the remote UE 302 (e.g., if the relay UE 304 assigns a temporary ID to the remote UE 302) or using the U2N connection mapping ID itself (e.g., if the U2N connection mapping ID is a Layer-2 ID, a GPSI, or a User Info ID of the remote UE 302).

In some aspects, as shown in FIG. 4B, the process 450 may include an optional step 470 in which the relay UE 304 sends a direct security mode command to the identified remote UE 302. In some aspects, the relay key response received in step 468 may further include a 5GPRUK ID, a KNR_ProSe, and/or a Nonce_2, and the direct security mode command sent in step 470 may include the 5GPRUK ID and/or the Nonce_2. In some aspects, the process 450 may further include the relay UE 304 deriving a PC5 session key Krelay-sess and/or confidentiality and integrity keys from KNR_ProSe.

In some aspects, as shown in FIG. 4B, the process 450 may include an optional step 472 in which the relay UE 304 receives a direct security complete message conveyed by the remote UE 302.

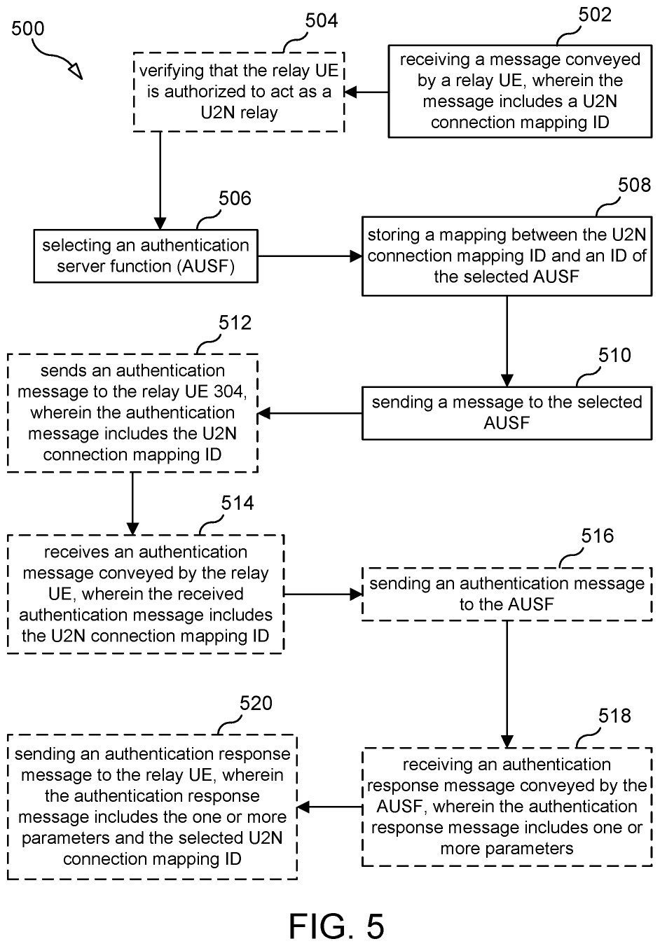

FIG. 5 illustrates a process 500 performed by a relay access and mobility function (AMF) 308.

In some aspects, the process 500 may include a step 502 in which the relay AMF 308 receives a message conveyed by a relay user equipment (UE) 303, and the message may include a UE-to-Network (U2N) connection mapping identification (ID). In some aspects, the U2N connection mapping ID may be a temporary ID. In some alternative aspects, the U2N connection mapping ID may be a Layer-2 ID of a remote UE 302. In some other alternative aspects, the U2N connection mapping ID may be a Generic Public Subscription Identifier (GPSI) of a remote UE 302. In some further alternative aspects, the U2N connection mapping ID may be a User Info ID of a remote UE 302.

In some aspects, the message conveyed by the relay UE 304 and received by the relay AMF 308 in step 502 may be a relay key request. In some aspects, the message conveyed by the relay UE 304 and received by the relay AMF 308 in step 502 may further include an ID of a remote UE 302, a subscription concealed identifier (SUCI) of the remote UE 302, a relay service code, and/or Nonce_1. In some aspects, the ID of the remote UE 302 may be a Layer-2 ID of the remote UE 302.

In some aspects, the process 500 may include an optional step 504 in which the relay AMF 308 verifies that the relay UE 304 is authorized to act as a U2N relay.

In some aspects, the process 500 may include a step 506 in which the relay AMF 308 selects an authentication server function (AUSF) 310. In some aspects, the AUSF may be selected based on the SUCI of the remote UE 302.

In some aspects, the process 500 may include a step 508 in which the relay AMF 308 stores a mapping between the U2N connection mapping ID and an ID of the selected AUSF 310.

In some aspects, the process 500 may include a step 510 in which the relay AMF 308 sends a message to the selected AUSF 310. In some aspects, the message sent to the selected AUSF 310 in step 510 may include the SUCI of the remote UE 302, the relay service code, and/or the Nonce_1. In some aspects, the message sent to the selected AUSF 310 in step 510 may be a Nausf_UEAuthentication_Authenticate Request message.

In some aspects, the process 500 may include an optional step 512 in which the relay AMF 308 sends an authentication message to the relay UE 304, and the authentication message may include the U2N connection mapping ID. In some aspects, the authentication message may further include an EAP message and/or one or more parameters.

In some aspects, the process 500 may include an optional step 514 in which the relay AMF 308 receives an authentication message conveyed by the relay UE 304, and the received authentication message may include the U2N connection mapping ID. In some aspects, the step 514 may further include using the received U2N connection mapping ID and the mapping to identify the selected AUSF 310.

In some aspects, the process 500 may include an optional step 516 in which the relay AMF 308 sends an authentication message to the identified AUSF 310. In some aspects, the authentication message received in step 514 may further include an EAP message and/or one or more parameters, and the authentication message sent in step 516 may include the EAP message and/or the one or more parameters. In some aspects, sending the authentication message to the identified AUSF 310 in step 516 may include calling the Nausf_UEAuthentication service of the identified AUSF 310.

In some aspects, the process 500 may include an optional step 518 in which the relay AMF 308 receives an authentication response message conveyed by the AUSF 310, and the authentication response message may include one or more parameters. In some aspects, the step 518 may further include using the mapping to select the U2N connection mapping ID. In some aspects, the process 500 may include an optional step 520 in which the relay AMF 308 sends an authentication response message to the relay UE 304, and the authentication response message may include the one or more parameters and the selected U2N connection mapping ID. In some aspects, the authentication response message sent in step 520 may be a relay key response. In some aspects, the one or more parameters may include a 5GPRUK ID, a KNR_ProSe, and/or a Nonce_2.

FIG. 6 is a block diagram of a UE 600 (e.g., UE 302 or 304), according to some aspects. As shown in FIG. 6, the UE 600 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like); communication circuitry 648, which is coupled to an antenna arrangement 649 comprising one or more antennas and which comprises a transmitter (Tx) 645 and a receiver (Rx) 647 for enabling UE 600 to transmit data and receive data (e.g., wirelessly transmit/receive data); and a local storage unit (a.k.a., “data storage system”) 608, which may include one or more non-volatile storage devices and/or one or more volatile storage devices. In some aspects where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 1142 may be a non-transitory computer readable medium, such as, magnetic media (e.g., a hard disk), optical media, memory devices (e.g., random access memory, flash memory), and the like. In some aspects, the CRI 644 of computer program 643 is configured such that when executed by PC 602, the CRI causes UE 600 to perform steps described herein (e.g., steps described herein with reference to flow charts FIGS. 3, 4A, and/or 4B). In other aspects, UE 600 may be configured to perform steps described herein without the need for code. That is, for example, PC 602 may consist merely of one or more ASICs. Hence, the features of the aspects described herein may be implemented in hardware and/or software.

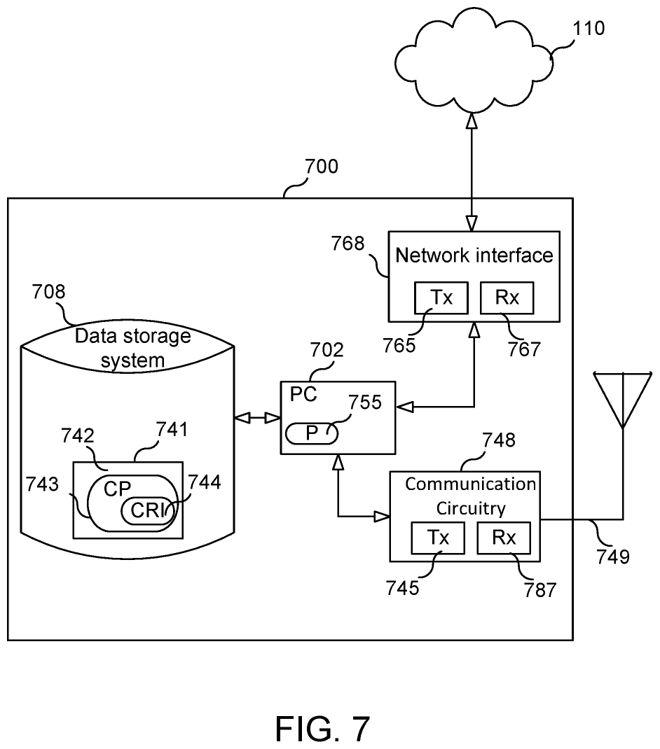

FIG. 7 is a block diagram of a network node 700 (e.g., the AMF 306, AMF 308, AUSF 310, and/or AUSF 312) according to some aspects. As shown in FIG. 7, the network node 700 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., the network node 704 may be a distributed computing apparatus); a network interface 768 comprising a transmitter (Tx) 765 and a receiver (Rx) 767 for enabling the network node 700 to transmit data to and receive data from other nodes connected to a network 110 (e.g., an Internet Protocol (IP) network) to which network interface 768 is connected; communication circuitry 748, which is coupled to an antenna arrangement 749 comprising one or more antennas and which comprises a transmitter (Tx) 745 and a receiver (Rx) 747 for enabling the network node 700 to transmit data and receive data (e.g., wirelessly transmit/receive data); and a local storage unit (a.k.a., “data storage system”) 708, which may include one or more non-volatile storage devices and/or one or more volatile storage devices. In aspects where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some aspects, the CRI 744 of computer program 743 is configured such that when executed by PC 702, the CRI causes the network node 700 to perform steps described herein (e.g., steps described herein with reference to FIG. 5). In other aspects, the network node 700 may be configured to perform steps described herein without the need for code. That is, for example, PC 702 may consist merely of one or more ASICs. Hence, the features of the aspects described herein may be implemented in hardware and/or software.

Some example embodiments of the present disclosure are as follows:

Embodiment A1: A method (400) performed by a relay user equipment, UE, (304), the method comprising: receiving a message conveyed by a remote UE (302); and sending a message to a relay access and mobility function, AMF, (308), wherein the sent message includes a UE-to-Network, U2N, connection mapping identification, ID, that identifies the remote UE.

Embodiment A2: The method of embodiment A1, wherein the message conveyed by the remote UE is a direct communication request, DCR, message.

Embodiment A3: The method of embodiment A1 or A2, wherein the message conveyed by the remote UE includes security capabilities of the remote UE, a security policy of the remote UE, a subscription concealed identifier (SUCI), a relay service code, and/or Nonce_1.

Embodiment A4: The method of embodiment A3, wherein the sent message including the U2N connection mapping ID further includes the ID of the remote UE, the SUCI, the relay service code, and/or the Nonce_1.

Embodiment A5: The method of any one of embodiments A1-A4, wherein the sent message including the U2N connection mapping ID is a relay key request.

Embodiment A6: The method of any one of embodiments A1-A5, further comprising: receiving an authentication message conveyed by a relay access and mobility function, AMF, (308), wherein the received authentication message includes the U2N connection mapping ID; using the received U2N connection mapping ID to identify the remote UE; and sending an authentication message to the identified remote UE.

Embodiment A7: The method of embodiment A6, wherein the received authentication message further includes an extensible authentication protocol, EAP, message and/or one or more parameters, and the sent authentication message includes the EAP message and/or the one or more parameters.

Embodiment A8: The method of embodiment A6 or A7, wherein the sent authentication message is a PC5-S message (e.g., a dedicated PC5-S message).

Embodiment A9: The method of any one of embodiments A6-A8, wherein the sent authentication message includes the U2N connection mapping ID.

Embodiment A10: The method of any one of embodiments A6-A8, wherein the sent authentication message does not include the U2N connection mapping ID.

Embodiment A11: The method of any one of embodiments A1-A10, further comprising: receiving an authentication message conveyed by the remote UE, wherein the received authentication message includes the U2N connection mapping ID; and sending an authentication message to a relay access and mobility function, AMF, (308), wherein the sent authentication message includes the U2N connection mapping ID.

Embodiment A12: The method of any one of embodiments A1-A10, further comprising: receiving an authentication message conveyed by the remote UE, wherein the received authentication message does not include the U2N connection mapping ID; and sending an authentication message to a relay access and mobility function, AMF, (308), wherein the sent authentication message includes the U2N connection mapping ID.

Embodiment A13: The method of embodiment A11 or A12, wherein the authentication message conveyed by the remote UE includes an extensible authentication protocol, EAP, message and/or one or more parameters, and the authentication message sent to the relay AMF includes the EAP message and/or the one or more parameters.

Embodiment A14: The method of any one of embodiments A11-A13, wherein the received authentication message is a PC5-S message (e.g., a dedicated PC5-S message).

Embodiment A15: The method of any one of embodiments A1-A14, further comprising: receiving a relay key response message conveyed by a relay access and mobility function, AMF, (308), wherein the relay key response includes the U2N connection mapping ID; using the received U2N connection mapping ID to identify the remote UE; and sending a message to the identified remote UE.

Embodiment A16: The method of embodiment A15, wherein the received relay key response message further includes a 5GPRUK ID, a K_{NR_ProSe}, and/or a Nonce_2, and the sent message includes the 5GPRUK ID and/or the Nonce_2.

Embodiment A17: The method of embodiment A16, further comprising deriving a PC5 session key Krelay-sess and/or confidentiality and integrity keys from K_{NR_ProSe}.

Embodiment A18: The method of any one of embodiments A15-A17, wherein the sent message is a direct security mode command.

Embodiment A19: The method of any one of embodiments A1-A18, further comprising receiving a direct security complete message conveyed by the remote UE.

Embodiment A20: The method of any one of embodiments A1-A19, further comprising assigning the U2N connection mapping ID to the remote UE.

Embodiment A21: The method of embodiment A20, wherein the U2N connection mapping ID is a temporary ID.

Embodiment A22: The method of embodiment A1-A21, further comprising storing a mapping between the U2N connection mapping ID and an ID of the remote UE.

Embodiment A23: The method of embodiment A22, wherein the ID of the remote UE is a Layer-2 ID of the remote UE.

Embodiment A24: The method of any one of embodiments A1-A19, wherein the U2N connection mapping ID is a Layer-2 ID of the remote UE.

Embodiment A25: The method of any one of embodiments A1-A19, A22, and A23, wherein the U2N connection mapping ID is a Generic Public Subscription Identifier (GPSI) of the remote UE.

Embodiment A26: The method of any one of embodiments A1-A19, A22, and A23, wherein the U2N connection mapping ID is a User Info ID of the remote UE.

Embodiment B1: A relay user equipment, UE, (304) configured to: receive a message conveyed by a remote UE (302); and send a message to a relay access and mobility function, AMF, (308), wherein the sent message includes a UE-to-Network, U2N, connection mapping identification, ID, that identifies the remote UE.

Embodiment C1: A method (500) performed by a relay access and mobility function, AMF, (308), the method comprising: receiving a message conveyed by a relay user equipment, UE, (304), wherein the message includes a UE-to-Network, U2N, connection mapping identification, ID; selecting an authentication server function, AUSF, (310); storing a mapping between the U2N connection mapping ID and an ID of the selected AUSF; and sending a message to the selected AUSF.

Embodiment C2: The method of embodiment C1, wherein the message conveyed by the relay UE is a relay key request.

Embodiment C3: The method of embodiment C1 or C2, wherein the message conveyed by the relay UE further includes an ID of a remote UE (302), a subscription concealed identifier (SUCI) of the remote UE, a relay service code, and/or Nonce_1.

Embodiment C4: The method of embodiment C3, wherein the ID of the remote UE is a Layer-2 ID of the remote UE.

Embodiment C5: The method of embodiment C3 or C4, wherein the message sent to the selected AUSF includes the SUCI of the remote UE, the relay service code, and/or the Nonce_1.

Embodiment C6: The method of any one of embodiments C3-C5, wherein the AUSF is selected based on the SUCI of the remote UE.

Embodiment C7: The method of any one of embodiments C1-C6, wherein the message sent to the selected AUSF is a Nausf_UEAuthentication_Authenticate Request message.

Embodiment C8: The method of any one of embodiments C1-C7, further comprising verifying that the relay UE is authorized to act as a U2N relay.

Embodiment C9: The method of any one of embodiments C1-C8, further comprising sending an authentication message to the relay UE, wherein the authentication message includes the U2N connection mapping ID.

Embodiment C10: The method of embodiment C9, wherein the authentication message further includes an extensible authentication protocol, EAP, message and/or one or more parameters.

Embodiment C11: The method of any one of embodiments C1-C11, further comprising: receiving an authentication message conveyed by the relay UE, wherein the received authentication message includes the U2N connection mapping ID; using the received U2N connection mapping ID and the mapping to identify the selected AUSF; and sending an authentication message to the identified AUSF.

Embodiment C12: The method of embodiment C11, wherein the received authentication message further includes an extensible authentication protocol, EAP, message and/or one or more parameters, and the sent authentication message includes the EAP message and/or the one or more parameters.

Embodiment C13: The method of embodiment C11 or C12, wherein sending the authentication message to the identified AUSF comprises calling the Nausf_UEAuthentication service of the identified AUSF.

Embodiment C14: The method of any one of embodiments C1-C13, further comprising: receiving an authentication response message conveyed by the AUSF, wherein the authentication response message includes one or more parameters; using the mapping to select the U2N connection mapping ID; and sending an authentication response message to the relay UE, wherein the authentication response message includes the one or more parameters and the selected U2N connection mapping ID.

Embodiment C15: The method of embodiment C14, wherein the sent authentication response message is a relay key response.

Embodiment C16: The method of embodiment C14 or C15, wherein the one or more parameters include a 5GPRUK ID, a K_{NR_ProSe}, and/or a Nonce_2.

Embodiment C17: The method of any one of embodiments C1-C16, wherein the U2N connection mapping ID is a temporary ID.

Embodiment C18: The method of any one of embodiments C1-C16, wherein the U2N connection mapping ID is a Layer-2 ID of a remote UE (302).

Embodiment C19: The method of any one of embodiments C1-C16, wherein the U2N connection mapping ID is a Generic Public Subscription Identifier (GPSI) of a remote UE (302).

Embodiment C20: The method of any one of embodiments C1-C16, wherein the U2N connection mapping ID is a User Info ID of a remote UE (302).

Embodiment D1: A relay access and mobility function, AMF, (308) configured to: receive a message conveyed by a relay user equipment, UE, (304), wherein the message includes a UE-to-Network, U2N, connection mapping identification, ID; select an authentication server function, AUSF, (310); store a mapping between the U2N connection mapping ID and an ID of the selected AUSF; and send a message to the selected AUSF.

Embodiment E1: A method (450) performed by a relay user equipment, UE, (304), the method comprising: receiving an authentication message conveyed by a relay access and mobility function, AMF, (308), wherein the received authentication message includes an extensible authentication protocol, EAP, message and/or one or more parameters; and sending a PC5-S message to a remote UE (302), wherein the PC5-S message includes the EAP message and/or the one or more parameters.

Embodiment E2: The method of embodiment E1, wherein the received authentication message includes a UE-to-Network, U2N, connection mapping identification, ID, and the method further comprises using the U2N connection mapping ID to identify the remote UE.

Embodiment E3: The method of embodiment E2, wherein the sent authentication message includes the U2N connection mapping ID.

Embodiment E4: The method of embodiment E2, wherein the sent authentication message does not include the U2N connection mapping ID.

Embodiment E5: The method of any one of embodiments E2-E4, further comprising: receiving a direct communication request, DCR, message conveyed by the remote UE; and sending a relay key request including the U2N connection mapping ID.

Embodiment E6: The method of embodiment E5, wherein the DCR message includes security capabilities of the remote UE, a security policy of the remote UE, a subscription concealed identifier (SUCI), a relay service code, and/or Nonce_1.

Embodiment E7: The method of embodiment E6, wherein the relay key request further includes the ID of the remote UE, the SUCI, the relay service code, and/or the Nonce_1.

Embodiment E8: The method of any one of embodiments E5-E7, further comprising: assigning the U2N connection mapping ID to the remote UE; and storing the mapping between the U2N connection mapping ID and the ID of the remote UE.

Embodiment E9: The method of embodiment E8, wherein using the U2N connection mapping ID to identify the remote UE comprises using the U2N connection mapping ID and the mapping to identify the remote UE.

Embodiment E10: The method of embodiment E9 or E10, wherein the ID of the remote UE is a Layer-2 ID of the remote UE.

Embodiment E11: The method of any one of embodiments E2-E10, further comprising: receiving an authentication message conveyed by the remote UE, wherein the received authentication message includes the U2N connection mapping ID; and sending an authentication message to the relay AMF, wherein the sent authentication message includes the U2N connection mapping ID.

Embodiment E12: The method of any one of embodiments E2-E10, further comprising: receiving an authentication message conveyed by the remote UE, wherein the received authentication message does not include the U2N connection mapping ID; and sending an authentication message to the relay AMF, wherein the sent authentication message includes the U2N connection mapping ID.

Embodiment E13: The method of embodiment E11 or E12, wherein the authentication message conveyed by the remote UE includes an extensible authentication protocol, EAP, message and/or one or more parameters, and the authentication message sent to the relay AMF includes the EAP message and/or the one or more parameters.

Embodiment E14: The method of any one of embodiments E11-E13, wherein the received authentication message is a PC5-S message (e.g., a dedicated PC5-S message).

Embodiment E15: The method of any one of embodiments E2-E14, further comprising: receiving a relay key response message conveyed by the relay AMF, wherein the relay key response includes the U2N connection mapping ID; using the received U2N connection mapping ID to identify the remote UE; and sending a direct security mode command to the identified remote UE.

Embodiment E16: The method of embodiment E15, wherein the received relay key response message further includes a 5GPRUK ID, a K_{NR_ProSe}, and/or a Nonce_2, and the direct security mode command includes the 5GPRUK ID and/or the Nonce_2.

Embodiment E17: The method of embodiment E16, further comprising deriving a PC5 session key Krelay-sess and/or confidentiality and integrity keys from K_{NR_ProSe}.

Embodiment E18: The method of any one of embodiments E2-E17, wherein the U2N connection mapping ID is a temporary ID.

Embodiment E19: The method of any one of embodiments E2-E17, wherein the U2N connection mapping ID is a Layer-2 ID of the remote UE.

Embodiment E20: The method of any one of embodiments E2-E17, wherein the U2N connection mapping ID is a Generic Public Subscription Identifier (GPSI) of the remote UE.

Embodiment E21: The method of any one of embodiments E2-E17, wherein the U2N connection mapping ID is a User Info ID of the remote UE.

Embodiment E22: The method of any one of embodiments E1-E21, further comprising receiving a direct security complete message conveyed by the remote UE.

Embodiment E23: The method of any one of embodiments E1-E22, wherein the PC5-S message is a dedicated PC5-S message.

Embodiment F1: A relay user equipment, UE, (304) configured to: receive an authentication message conveyed by a relay access and mobility function, AMF, (308); and send an authentication message to a remote UE (302), wherein the sent authentication message is a PC5-S message.

Embodiment G1: A computer program comprising instructions for adapting an apparatus to perform the method of any one of embodiments A1-A26, C1-C20, and E1-E23.

Embodiment H1: A carrier containing the computer program of embodiment G1, wherein the carrier is one of an electronic signal, optical signal, radio signal, or compute readable storage medium.

Embodiment I1: An apparatus (304 or 308), the apparatus comprising: processing circuitry (602 or 702); and a memory (642 or 742), said memory containing instructions (644 or 744) executable by said processing circuitry, whereby said apparatus is operative to perform the method of any one of the embodiments A1-A26, C1-C20, and E1-E23.

Embodiment J1: An apparatus (304 or 308) adapted to perform the method of any one of embodiments A1-A26, C1-C20, and E1-E23.

Embodiment K1: Any combination of the embodiments set forth above.

While various aspects and embodiments are described herein, it should be understood that they have been presented by way of example only, and not limitation. Thus, the breadth and scope of this disclosure should not be limited by any of the above-described exemplary aspects and embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a relay user equipment, UE, the method comprising:
receiving a first message conveyed by a remote UE; and
sending a second message to a relay access and mobility function, AMF, wherein the second message comprises a UE-to-Network, U2N, connection mapping identification, ID, that identifies the remote UE.

2. The method of claim 1, wherein the second message further comprises a subscription concealed identifier, ID, of the remote UE.

3. The method of claim 2, wherein the second message further comprises: a relay service code received in the first message, a nonce received in the first message, or both a relay service code received in the first message and a nonce received in the first message.

4. The method of claim 1, wherein the second message is a relay key request.

5. The method of claim 1, wherein the first message is a direct communication request, DCR, message.

6. The method of claim 1, further comprising:
receiving a first authentication message conveyed by the relay AMF, wherein the authentication message includes the U2N connection mapping ID that identifies the remote UE; and
sending a second authentication message to the remote UE identified by the U2N connection mapping ID comprised in the first authentication message.

7. The method of claim 6, wherein the first authentication message further comprises an extensible authentication protocol, EAP, message and/or one or more parameters, and the second authentication message comprises the EAP message and/or the one or more parameters.

8. The method of claim 6, wherein the second authentication message is a PC5-S message.

9. The method of claim 6, wherein the first authentication message is a relay authentication request.

10. The method of claim 1, further comprising:
receiving a third authentication message conveyed by the remote UE; and
sending a fourth authentication message to the relay AMF, wherein the fourth authentication message comprises the U2N connection mapping ID that identifies the remote UE.

11. The method of claim 10, wherein the third authentication message comprises an extensible authentication protocol, EAP, message and/or one or more parameters, and the fourth authentication message comprises the EAP message and/or the one or more parameters.

12. The method of claim 10, wherein the third authentication message is a PC5-S message.

13. The method of claim 1, further comprising:
receiving a relay key response message conveyed by the relay AMF, wherein the relay key response comprises the U2N connection mapping ID that identifies the remote UE; and
sending a message to the remote UE identified by the U2N connection mapping ID comprised in the relay key response message.

14. The method of claim 13, wherein the relay key response message further comprises a 5GPRUK ID, a K_{NR_ProSe}, and/or a Nonce_2, and the sent message comprises the 5GPRUK ID and/or the Nonce_2.

15. The method of claim 14, further comprising deriving a PC5 session key Krelay-sess and/or confidentiality and integrity keys from K_{NR_ProSe}.

16. The method of claim 13, wherein the sent message is a direct security mode command.

17. The method of claim 1, further comprising receiving a direct security complete message conveyed by the remote UE.

18. The method of claim 1, further comprising assigning the U2N connection mapping ID to the remote UE.

19. The method of claim 1, wherein the U2N connection mapping ID is a temporary ID.

20. The method of a m claim 1, further comprising storing a mapping between the U2N connection mapping ID and an ID of the remote UE.

21. The method of claim 20, wherein the ID of the remote UE is a Layer-2 ID of the remote UE.

22-26. (canceled)

27. A relay user equipment, UE, comprising:
communication circuitry; and
processing circuitry associated with the communication circuitry, the processing circuitry configured to cause the UE to:
receive a first message conveyed by a remote UE; and
send a second message to a relay access and mobility function, AMF, wherein the second message comprises a UE-to-Network, U2N, connection mapping identification, ID, that identifies the remote UE.

28. (canceled)

29. A method performed by a relay access and mobility function, AMF, the method comprising:
receiving a first message conveyed by a relay user equipment, UE, wherein the first message comprises a UE-to-Network, U2N, connection mapping identification, ID, that identifies a remote UE;
selecting an authentication server function, AUSF;
storing a mapping between the U2N connection mapping ID and an ID of the selected AUSF; and
sending a second message to the selected AUSF.

30. The method of claim 29, wherein the first message further comprises a subscription concealed identifier, ID, of the remote UE.

31. The method of claim 30, wherein the first message further comprises: a relay service code, a nonce, or both a relay service code and a nonce.

32. The method of claim 29, wherein the first message is a relay key request.

33. The method of claim 29, wherein the second message sent to the selected AUSF comprises: (a) a subscription concealed identifier, ID, of the remote UE, (b) a relay service code, (c) a nonce, or (d) a combination of any two or more of (a)-(d).

34. The method of claim 29, wherein the second message sent to the selected AUSF comprises a subscription concealed identifier, ID, of the remote UE, and selecting the AUSF comprises selecting the AUSF based on the subscription concealed ID of the remote UE.

35. The method of claim 29, wherein the message sent to the selected AUSF is a Nausf_UEAuthentication_Authenticate Request message.

36. The method of claim 29, further comprising verifying that the relay UE is authorized to act as a U2N relay.

37. The method of claim 29, further comprising sending a first authentication message to the relay UE, wherein the first authentication message comprises the U2N connection mapping ID.

38. The method of claim 37, wherein the first authentication message further comprises an extensible authentication protocol, EAP, message and/or one or more parameters.

39. The method of claim 29, further comprising:
receiving a second authentication message conveyed by the relay UE, wherein the second authentication message comprises the U2N connection mapping ID; and
sending a third authentication message to the AUSF mapped to the USN connection mapping ID comprised in the second authentication message.

40. The method of claim 39, wherein the second authentication message further comprises an extensible authentication protocol, EAP, message and/or one or more parameters, and the third authentication message comprises the EAP message and/or the one or more parameters comprised in the second authentication message.

41. The method of claim 39, wherein sending the third authentication message to the AUSF comprises calling the Nausf_UEAuthentication service of the AUSF.

42. The method of claim 39, further comprising:
receiving an authentication response message conveyed by the AUSF, wherein the authentication response message comprises one or more parameters;
sending an authentication response message to the relay UE, wherein the authentication response message comprises the one or more parameters comprised in the received authentication response and the U2N connection mapping ID.

43. The method of claim 42, wherein the sent authentication response message is a relay key response.

44. The method of claim 42, wherein the one or more parameters comprised in the received authentication response comprise a 5GPRUK ID, a K_{NR_ProSe}, and/or a Nonce_2.

45. The method of claim 29, wherein the U2N connection mapping ID is a temporary ID.

46. The method of claim 29, wherein the U2N connection mapping ID is a Layer-2 ID of the remote UE.

47. The method of claim 29, wherein the U2N connection mapping ID is a Generic Public Subscription Identifier, GPSI, of the remote UE.

48. The method of claim 29, wherein the U2N connection mapping ID is a User Info ID of the remote UE.

49-50. (canceled)

51. A relay access and mobility function, AMF, comprising:
a network interface; and
processing circuitry associated with the network interface, the processing circuitry configured to cause the relay AMF to:
receive a first message conveyed by a relay user equipment, UE, wherein the first message comprises a UE-to-Network, U2N, connection mapping identification, ID, that identifies a remote UE;
select an authentication server function, AUSF;
store a mapping between the U2N connection mapping ID and an ID of the selected AUSF; and
send a second message to the selected AUSF.

52. (canceled)

53. The relay UE of claim 27, wherein the second message further comprises a subscription concealed identifier, ID, of the remote UE.

54. The relay UE of claim 53, wherein the second message further comprises: a relay service code received in the first message, a nonce received in the first message, or both a relay service code received in the first message and a nonce received in the first message.

55. The relay UE of claim 27, wherein the second message is a relay key request.

56. The relay UE of claim 27, wherein the first message is a direct communication request, DCR, message.

57. The relay UE of claim 27, wherein the processing circuitry is further configured to cause the UE to:
receive a first authentication message conveyed by the relay AMF, wherein the authentication message includes the U2N connection mapping ID that identifies the remote UE; and
send a second authentication message to the remote UE identified by the U2N connection mapping ID comprised in the first authentication message.

58. The relay UE of claim 57, wherein the first authentication message further comprises an extensible authentication protocol, EAP, message and/or one or more parameters, and the second authentication message comprises the EAP message and/or the one or more parameters.

59. The relay UE of claim 57, wherein the second authentication message is a PC5-S message.

60. The relay UE of claim 57, wherein the first authentication message is a relay authentication request.

61. The relay UE of claim 27, wherein the processing circuitry is further configured to cause the UE to:
receive a third authentication message conveyed by the remote UE; and
send a fourth authentication message to the relay AMF, wherein the fourth authentication message comprises the U2N connection mapping ID that identifies the remote UE.

62. The relay UE of claim 61, wherein the third authentication message comprises an extensible authentication protocol, EAP, message and/or one or more parameters, and the fourth authentication message comprises the EAP message and/or the one or more parameters.

63. The relay UE of claim 61, wherein the third authentication message is a PC5-S message.

64. The relay UE of claim 27, wherein the processing circuitry is further configured to cause the UE to:
receive a relay key response message conveyed by the relay AMF, wherein the relay key response comprises the U2N connection mapping ID that identifies the remote UE; and
send a message to the remote UE identified by the U2N connection mapping ID comprised in the relay key response message.

65. The relay UE of claim 64, wherein the relay key response message further comprises a 5GPRUK ID, a K_{NR_ProSe}, and/or a Nonce_2, and the sent message comprises the 5GPRUK ID and/or the Nonce_2.

66. The relay UE of claim 65, wherein the processing circuitry is further configured to cause the UE to derive a PC5 session key Krelay-sess and/or confidentiality and integrity keys from K_{NR_ProSe}.

67. The relay UE of claim 64, wherein the sent message is a direct security mode command.

68. The relay UE of claim 27, wherein the processing circuitry is further configured to cause the UE to receive a direct security complete message conveyed by the remote UE.

69. The relay UE of claim 27, wherein the processing circuitry is further configured to cause the UE to assign the U2N connection mapping ID to the remote UE.

70. The relay UE of claim 27, wherein the U2N connection mapping ID is a temporary ID.

71. The relay UE of claim 27, wherein the processing circuitry is further configured to cause the UE to store a mapping between the U2N connection mapping ID and an ID of the remote UE.

72. The relay UE of claim 71, wherein the ID of the remote UE is a Layer-2 ID of the remote UE.

73. The relay AMF of claim 51, wherein the first message further comprises a subscription concealed identifier, ID, of the remote UE.

74. The relay AMF of claim 73, wherein the first message further comprises: a relay service code, a nonce, or both a relay service code and a nonce.

75. The relay AMF of claim 51, wherein the first message is a relay key request.

76. The relay AMF of claim 51, wherein the second message sent to the selected AUSF comprises: (a) a subscription concealed identifier, ID, of the remote UE, (b) a relay service code, (c) a nonce, or (d) a combination of any two or more of (a)-(d).

77. The relay AMF of claim 51, wherein the second message sent to the selected AUSF comprises a subscription concealed identifier, ID, of the remote UE, and selecting the AUSF comprises selecting the AUSF based on the subscription concealed ID of the remote UE.

78. The relay AMF of claim 51, wherein the message sent to the selected AUSF is a Nausf_UEAuthentication_Authenticate Request message.

79. The relay AMF of claim 51, wherein the processing circuitry is further configured to cause the relay AMF to verify that the relay UE is authorized to act as a U2N relay.

80. The relay AMF of claim 51, wherein the processing circuitry is further configured to cause the relay AMF to send a first authentication message to the relay UE, wherein the first authentication message comprises the U2N connection mapping ID.

81. The relay AMF of claim 80, wherein the first authentication message further comprises an extensible authentication protocol, EAP, message and/or one or more parameters.

82. The relay AMF of claim 51, wherein the processing circuitry is further configured to cause the relay AMF to:
receive a second authentication message conveyed by the relay UE, wherein the second authentication message comprises the U2N connection mapping ID; and
send a third authentication message to the AUSF mapped to the USN connection mapping ID comprised in the second authentication message.

83. The relay AMF of claim 82, wherein the second authentication message further comprises an extensible authentication protocol, EAP, message and/or one or more parameters, and the third authentication message comprises the EAP message and/or the one or more parameters comprised in the second authentication message.

84. The relay AMF of claim 82, wherein sending the third authentication message to the AUSF comprises calling the Nausf_UEAuthentication service of the AUSF.

85. The relay AMF of claim 82, wherein the processing circuitry is further configured to cause the relay AMF to:
receive an authentication response message conveyed by the AUSF, wherein the authentication response message comprises one or more parameters;
send an authentication response message to the relay UE, wherein the authentication response message comprises the one or more parameters comprised in the received authentication response and the U2N connection mapping ID.

86. The relay AMF of claim 85, wherein the sent authentication response message is a relay key response.

87. The relay AMF of claim 85, wherein the one or more parameters comprised in the received authentication response comprise a 5GPRUK ID, a K_{NR_ProSe}, and/or a Nonce_2.

88. The relay AMF of claim 51, wherein the U2N connection mapping ID is a temporary ID.

89. The relay AMF of claim 51, wherein the U2N connection mapping ID is a Layer-2 ID of the remote UE.

90. The relay AMF of claim 51, wherein the U2N connection mapping ID is a Generic Public Subscription Identifier, GPSI, of the remote UE.

91. The relay AMF of claim 51, wherein the U2N connection mapping ID is a User Info ID of the remote UE.
